(19) United States
(12) Patent Application Publication
(10) Pub. No.: US 2013/0286949 A1
(43) Pub. Date: Oct. 31, 2013

(54) WIRELESS COMMUNICATION SYSTEM, BASE STATION APPARATUS, MOBILE STATION APPARATUS AND COMMUNICATION METHOD IN WIRELESS COMMUNICATION SYSTEM

(71) Applicants: Hiromichi Tomeba, Osaka-shi (JP); Shimpei To, Osaka-shi (JP); Takashi Onodera, Osaka-shi (JP); Hideo Namba, Osaka-shi (JP); Hiroshi Nakano, Osaka-shi (JP); Alvaro Ruiz Delgado, Osaka-shi (JP)

(72) Inventors: Hiromichi Tomeba, Osaka-shi (JP); Shimpei To, Osaka-shi (JP); Takashi Onodera, Osaka-shi (JP); Hideo Namba, Osaka-shi (JP); Hiroshi Nakano, Osaka-shi (JP); Alvaro Ruiz Delgado, Osaka-shi (JP)

(73) Assignee: SHARP KABUSHIKI KAISHA, Osaka-shi, Osaka (JP)

(21) Appl. No.: 13/989,516

(22) PCT Filed: Nov. 24, 2011
(86) PCT No.: PCT/JP2011/077031

§ 371 Date: Jul. 3, 2013

(30) Foreign Application Priority Data
Nov. 24, 2010 (JP) 2010 260803

(51) Int. Cl. H04W 72/04; H04B 7/04

(52) U.S. Cl. CPC H04W 72/0406; H04B 7/0452
USPC 370/328

(57) ABSTRACT

A wireless communication system includes a base station apparatus having a plurality of antennas and a plurality of mobile station apparatuses each having, at least, one antenna. The base station apparatus acquires channel state information of the plurality of mobile station apparatuses, based on any one of a plurality of different channel state information formats, and, separately precodes data signals addressed to the plurality of mobile station apparatuses based on the channel state information, and spatially multiplexes and transmits the precoded signals. The mobile station apparatus receives the precoded signals and detects a desired data signal from the multiplexed signals addressed to mobile station apparatuses, based on the channel state information. With this scheme, it is possible to realize a new spatial multiplexing technology that enables a plurality of mobile station apparatuses using different CSI feedback schemes to be spatially multiplexed on the same wireless resource in the downlink MU-MIMO transmission.

### TECHNICAL FIELD

The present invention relates to a wireless communication system and the like, which include a base station apparatus having a plurality of antennas and a plurality of mobile station apparatus each of which at least having one antenna.

### BACKGROUND ART

In Long Term Evolution (LTE) which has been standardized as the 3.9 generation wireless transmission scheme by the 3^{rd} Generation Partnership Project (3GPP), in order to achieve large improvement of frequency efficiency from the 3^{rd} generation wireless transmission scheme, Multiple Input Multiple Output (MIMO) technology that performs wireless transmission using a plurality of transmit and receive antennas have been specified.

By spatial multiplexing (SM) technique as one of MIMO techniques, it is possible to achieve improvement of transmission rate without enlarging the frequency bandwidth. Further, at present, as a prospect of the fourth generation wireless transmission scheme, LTE-Advanced (LTE-A) was proposed and has been actively standardized. In LTE-A, in order to achieve a peak transmission rate of 1 Gbps for downlink transmission (from base station apparatus to mobile station apparatus), single-user MIMO (SU-MIMO) that can spatially multiplex a maximum of eight streams has been studied. The SU-MIMO is a MIMO transmission scheme for a base station apparatus having a plurality of transmit antennas and a single mobile station apparatus having a plurality of receive antennas.

However, there is a limit to the number of receive antennas that can be provided in one mobile station apparatus. For this reason, it has been considered that use of multi-user MIMO (MU-MIMO) in which a plurality of mobile station apparatus that are connected at the same time are regarded to form a virtual large-scale antenna array while transmitted signals from the base station apparatus to individual mobile station apparatus are spatially multiplexed, is indispensable to improve frequency efficiency, so that MU-MIMO has already been specified in LTE Release 8 (Rel 8). The MU-MIMO that is adopted in Rel 8 is based on a scheme called beam-forming that multiplies linear filter at the base station apparatus. Linear MU-MIMO using linear filers is regarded as the likest to be adopted in systems in Rel. 9 and beyond.

By the way, in the downlink linear MU-MIMO technology, the base station apparatus needs to grasp the channel state information (CSI) between the base station apparatus and the mobile station apparatus. When a frequency division duplex (FDD) system, which uses a different carrier frequency for the uplink (from mobile station apparatus to base station apparatus) transmission and the downlink transmission, is adopted as the duplex scheme, the mobile station apparatus needs to feed back CSI to the base station apparatus.

In a time division duplex (TDD) system which uses the same carrier frequency for uplink and downlink, it is possible on the base station apparatus side to directly estimate CSI, taking advantage of the duality of the channels. However, because it is necessary to execute antenna calibration between the base station apparatus and the mobile station apparatus, there is a case in which CSI feedback is needed in the TDD system, like the FDD system. Several kinds of CSI feedback schemes have been investigated heretofore. Of these, the implicit CSI feedback scheme and the explicit CSI feedback scheme are known as representative methods.

The implicit CSI feedback scheme does not notify channel state information itself but gives information that suggests channel state information. As one of the implicit CSI feedback schemes, there is a feedback scheme adopted in LTE Rel. 8.

In LTE Rel. 8, the mobile station apparatus, based on the estimated CSI, calculates a transmission linear filter for which the base station apparatus is desired to multiply by the transmitted signal addressed to its own mobile station apparatus. Then, from a code book in which a plurality of linear filters shared by the mobile station apparatus and the base station apparatus are written, a linear filter that most resembles the transmission linear filter calculated before is extracted and its number is notified to the base station apparatus.

That is, it can be said that instead of directly notifying the channel state information estimated by the mobile station apparatus, the mobile station notifies the base station apparatus of the method of the transmission coding process (precoding) which the mobile station apparatus desires based on the estimated channel state information. Linear MU-MIMO based on the implicit CSI feedback scheme is described in non-patent document 1, for example.

On the other hand, the explicit CSI feedback scheme is a scheme that notifies information directly expressing the channel state information itself. Specifically proposed is a method of notifying the CSI itself which the mobile station apparatus estimated, or the most preferable quantized point to its own station after quantization of the estimated CSI of the mobile station apparatus, to the base station apparatus. When explicit CSI is fed back, it is also possible for the base station apparatus to actively determine the precoding method. As to linear MU-MIMO based on the explicit CSI feedback scheme, specific examples are shown in non-patent document 1 and non-patent document 2, for example.

### PRIOR ART DOCUMENTS

### Non-patent Documents

Non-patent document 1: 3GPP R1-100501, NTT DOCOMO, “Performance of DL MU-MIMO based on implicit feedback scheme in LTE-Advanced,” January 2010.
Non-Patent Document 2: 3GPP R1-094242, NTT DOCOMO, “Investigation on enhanced DL MU-MIMO processing based on channel vector quantization for LTE-Advanced,” October 2009.

### SUMMARY OF THE INVENTION

### Problems to be Solved by the Invention

In the case of LTE Rel. 8, the implicit CSI feedback scheme is adopted because this scheme is a relatively simple technique and characterized by small overhead. At present, it has been determined that the implicit CSI feedback scheme is adopted or regarded as the most likely candidate in the enhanced versions, or LTE Rel. 9 and LTE Rel. 10 (LTE Rel. 10 may be sometimes called LTE-A).

However, there is a limit to improvement in frequency efficiency in linear MU-MIMO based on implicit CSI, so that it can be said that there is a very high possibility that a feedback scheme other than the implicit CSI feedback scheme is adopted in the future, in LTE Rel. 11 and beyond.

But, if, for example an explicit CSI feedback scheme is adopted as the feedback scheme other than implicit CSI, in LTE Rel. 11 and beyond, there will coexist the mobile station apparatus using explicit CSI feedback (will be called first mobile station apparatus) and the mobile station apparatus using implicit CSI feedback (will be called second mobile station apparatus).

At this point, the MU-MIMO proposed heretofore is presumed to be applied to the case where all mobile station apparatus are the first mobile station apparatuses (FIG. 11(a)) or to the case where all mobile station apparatus are the second mobile station apparatuses (FIG. 11(b)). So, there occurs the problem that the first mobile station apparatus and the second mobile station apparatus cannot be spatially multiplexed in the case where the first mobile station apparatus and the second mobile station apparatus coexist and connect to the base station apparatus (FIG. 11(c)).

Further, it is possible to spatially multiplex first mobile station apparatuses only or second mobile station apparatuses only in the proposed scheme heretofore. However, restrictions are imposed on user scheduling and the like, setting a limit to improvement of frequency efficiency.

Accordingly, it is desired that the mobile station apparatus using explicit CSI feedback and the mobile station apparatus using implicit CSI feedback can be spatially multiplexed with each other. However, in the existing circumstances no method that enables spatially multiplexing of these two on the same wireless resource has been invented.

In this way, when mobile station apparatuses using different CSI feedback schemes coexist, it is impossible to spatially multiplex the two on the same wireless resource. This means that improvement in frequency efficiency is limited.

The present invention has been devised in view of the above circumstances, it is therefore an object of the present invention to provide a wireless communication system and the like which realize a new spatial multiplexing technology that enables a plurality of mobile station apparatuses having different CSI feedback schemes to be spatially multiplexed on the same wireless resource in downlink MU-MIMO transmission.

### Means for Solving the Problems

In view of the above object, the wireless communication system of the present invention resides a wireless communication system comprising: a base station apparatus having a plurality of antennas and a plurality of mobile station apparatuses each having, at least, one antenna, and is characterized in that the base station apparatus, acquires channel state information of the plurality of mobile station apparatuses, based on any one of a plurality of different channel state information formats, and,

separately precodes data signals addressed to the plurality of mobile station apparatuses based on the channel state information, and spatially multiplexes and transmits the precoded signals; and

the mobile station apparatus receives the precoded signals and detects a desired data signal from the multiplexed signals addressed to mobile station apparatuses, based on the channel state information.

The wireless communication system of the present invention is characterized in that the plurality of mobile station apparatuses include a first mobile station apparatus and a second mobile station apparatus,

the first mobile station apparatus notifies channel state information between itself and the base station apparatus to the base station apparatus, based on a first channel state information format, and,

the second mobile station apparatus notifies channel state information between itself and the base station apparatus to the base station apparatus, based on a second channel state information format.

The wireless communication system of the present invention is characterized in that the first channel state information format is an information format that explicitly indicates the channel state information between the base station apparatus and the mobile station apparatus and is comprised of any one of information, among a complex channel matrix between the base station apparatus and the mobile station apparatus, a covariance matrix of a complex channel matrix between the base station apparatus and the mobile station apparatus, or a complex channel matrix represented by a matrix product of a complex channel matrix between the base station apparatus and the mobile station apparatus and a receive filter matrix that is applied in the mobile station apparatus.

The wireless communication system of the present invention is characterized in that the second channel state information format is an information format that implicitly indicates the channel state information between the base station apparatus and the mobile station apparatus and is comprised of control information associated with precoding which the mobile station apparatus requests from the base station apparatus.

The wireless communication system of the present invention is characterized in that the control information associated with the precoding is control information for notifying the base station apparatus of a linear filter which the mobile station apparatus requests, based on a plurality of linear filters included in a known code book between the base station apparatus and the mobile station apparatus.

The wireless communication system of the present invention is characterized in that the base station apparatus, acquires the channel state information of the plurality of mobile station apparatuses, based on anyone of the plurality of different channel state information formats,

generates a first linear filter based on the channel state information,

separately precodes data signals addressed to the plurality of mobile station apparatuses based on the channel state information and the first linear filter, and

spatially multiplexes and transmits the precoded signals so as to give a notice of control information associated with the first linear filter to the mobile station apparatus.

The wireless communication system of the present invention is characterized in that the first linear filter is determined based on either a criterion for minimizing transmission power required for transmitting the precoded signal or a criterion for maximizing a traffic capacity of the wireless communication system.

The wireless communication system of the present invention is characterized in that the control information is control information for giving notice of the first linear filter from the base station apparatus to the mobile station apparatus, based on a plurality of linear filters included in a known code book between the base station apparatus and the mobile station apparatus.

The wireless communication system of the present invention is characterized in that the base station apparatus, acquires the channel state information of the plurality of mobile station apparatuses, based on any one of the plurality of different channel state information formats, and,

separately precodes data signals addressed to the plurality of mobile station apparatuses, based on the channel state information and a plurality of second linear filters, respectively associated with a plurality of eigenvalues of a channel matrix calculated from the first channel state information format, spatially multiplexes and transmits the precoded signals, and

the base station apparatus gives notice of control information associated with the second linear filters to the mobile station apparatus.

The wireless communication system of the present invention is characterized in that the base station apparatus determines a linear filter to be used for the precoding, from the plurality of second linear filters, to thereby determine an antenna port to use.

The wireless communication system of the present invention is characterized in that the precoding is non-linear signal processing including a modulo operation.

The base station apparatus of the present invention resides in a base station apparatus, having a plurality of antennas, and connected to a wireless communication system including a plurality of mobile station apparatuses each having, at least, one antenna, and comprises:

a channel state information acquisition unit for acquiring channel state information of the plurality of mobile station apparatuses, based on any one of a plurality of different channel state information formats, and,

a precoding unit for separately precoding data signals addressed to the plurality of mobile station apparatuses, based on the channel state information; and,

a transmitter for spatially multiplexing a precoded signal that enables the mobile station apparatus to detect a desired data signal from the multiplexed signals addressed to mobile station apparatuses, based on the channel state information when the mobile station apparatus receives the precoded signal.

The mobile station apparatus of the present invention resides in a mobile station apparatus connected to a wireless communication system including a base station apparatus having a plurality of antennas and a plurality of mobile station apparatuses each having, at least, one antenna, and is characterized in that

a base station apparatus includes: a channel state information acquisition unit for acquiring channel state information of a plurality of mobile station apparatuses, based on any one of a plurality of different channel state information formats; and,

a transmitter for separately precoding data signals addressed to the plurality of mobile station apparatuses, based on the channel state information and spatially multiplexing and transmitting the precoded signals, and,

the mobile station apparatus includes a detector for receiving the precoded signals and detecting a desired data signal from multiplexed signals addressed to mobile station apparatuses, based on the channel state information.

The communication method of the present invention resides in a communication method in a wireless communication system including a base station apparatus having a plurality of antennas and a plurality of mobile station apparatuses each having, at least, one antenna, wherein

a base station apparatus includes the steps of:

acquiring channel state information of a plurality of mobile station apparatuses, based on any one of a plurality of different channel state information formats, and,

separately precoding data signals addressed to the plurality of mobile station apparatuses based on the channel state information and spatially multiplexing and transmitting the precoded signals; and

a mobile station apparatus includes the step of:

receiving the precoded signals and detecting a desired data signal from the multiplexed signals addressed to mobile station apparatuses, based on the channel state information.

### Advantages of the Invention

According to the present invention, it is possible to realize a wireless communication system and the like that enables a plurality of mobile station apparatuses using different CSI feedback schemes to be spatially multiplexed on the same wireless resource in the downlink MU-MIMO transmission.

### BRIEF DESCRIPTION OF DRAWINGS

FIG. 1 is a diagram for illustrating the outline of a wireless communication system when the present invention is applied.

FIG. 2 is a diagram for illustrating the configuration of a base station apparatus in the first embodiment.

FIG. 3 is a diagram for illustrating the configuration of a precoding unit in the first embodiment.

FIG. 4 is a diagram for illustrating the configuration of a first mobile station apparatus in the first embodiment.

FIG. 5 is a diagram for illustrating the configuration of a second mobile station apparatus in the first embodiment.

FIG. 6 is a diagram for illustrating the configuration of a base station apparatus in the second embodiment.

FIG. 7 is a diagram for illustrating the configuration of a precoding unit in the second embodiment.

FIG. 8 is a diagram for illustrating the configuration of a mobile station apparatus in the second embodiment.

FIG. 9 is a diagram for illustrating the configuration of a precoding unit in the third embodiment.

FIG. 10 is a diagram for illustrating the configuration of a precoding unit in the fourth embodiment.

FIG. 11 is a diagram for illustrating a wireless communication system in the prior art.

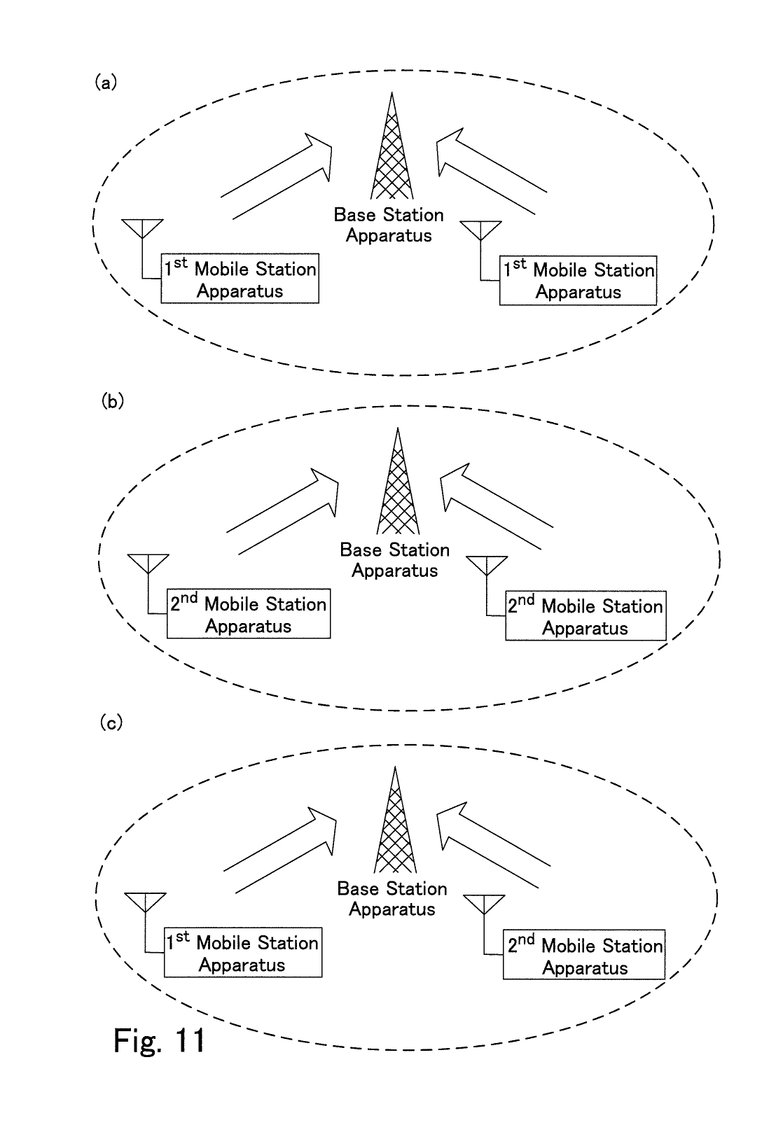

### MODES FOR CARRYING OUT THE INVENTION

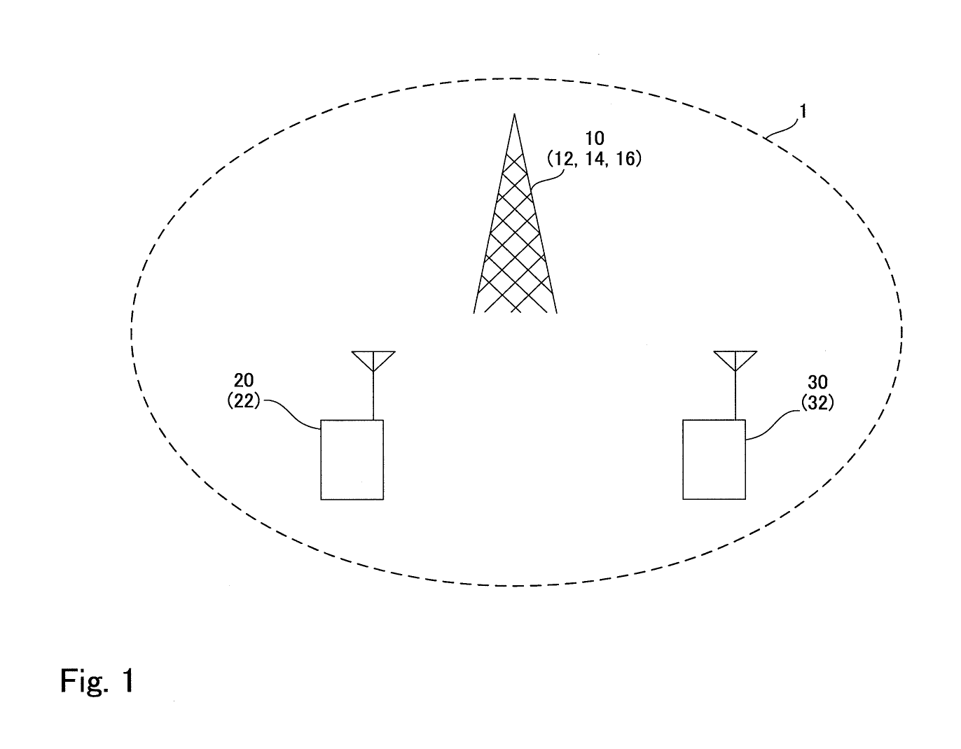

Now, the best modes for carrying out the present invention will be described with reference to the drawings. First, FIG. 1 is a diagram showing the outline of a mobile communication system when the present invention is applied. In a mobile communication system 1, a first mobile station apparatus 20 and a second mobile station apparatus 30 are connected to a base station apparatus 10. Hereinbelow, different embodiments in this mobile communication system 1 will be described.

### The First Embodiment

The first embodiment according to the present invention is targeted at communications of a plurality of mobile station apparatuses (also called receiving apparatuses or mobile terminals) each of which having Nᵣ numbers of receive antennas, connected to the base station apparatus 10 (also called transmitting apparatus) having Nₜ numbers of transmit antennas. The maximum number U of mobile station apparatus to be spatially multiplexed on the same wireless resource is assumed to be two.

However, since spatial multiplexing as many number of apparatus as to satisfy Nₜ≧R×U (R is the rank number to be described later) can be done, the number of mobile station apparatus to be spatially multiplexed on the same wireless resource is not limited to two.

Further, in the following description, though it is assumed for simplicity that each mobile station apparatus is engaged in communication of one data stream only, the mobile station apparatus of each user can also transmit at the same time as many number of data streams as the number of receive antennas the mobile station apparatus has.

Moreover, the number of receive antennas each mobile station apparatus has may be different from others, and the number of data streams to be transmitted to each mobile station apparatus may be different from others. Hereinbelow, the number of data streams the base station apparatus transmits per each mobile station apparatus will be called “rank number”, and transmission of R data streams will be called transmission of rank R.

A plurality of mobile station apparatuses feed back CSI feedback in different methods (formats). In the following description, a mobile station apparatus that feeds back the explicit CSI is called the first mobile station apparatus 20 (receiving apparatus) while a mobile station apparatus that feeds back the implicit CSI is called the second mobile station apparatus 30 (receiving apparatus).

If there exists a terminal that can feed back both of the implicit SCI and the explicit CSI, this terminal may be regarded as either first mobile station apparatus 20 or second mobile station apparatus 30. Specific examples of the implicit CSI and the explicit CSI will be described later. In the following description, the explicit CSI will be also called a first channel state information format and the implicit CSI will be called a second channel state information format.

[Base Station Apparatus Configuration]

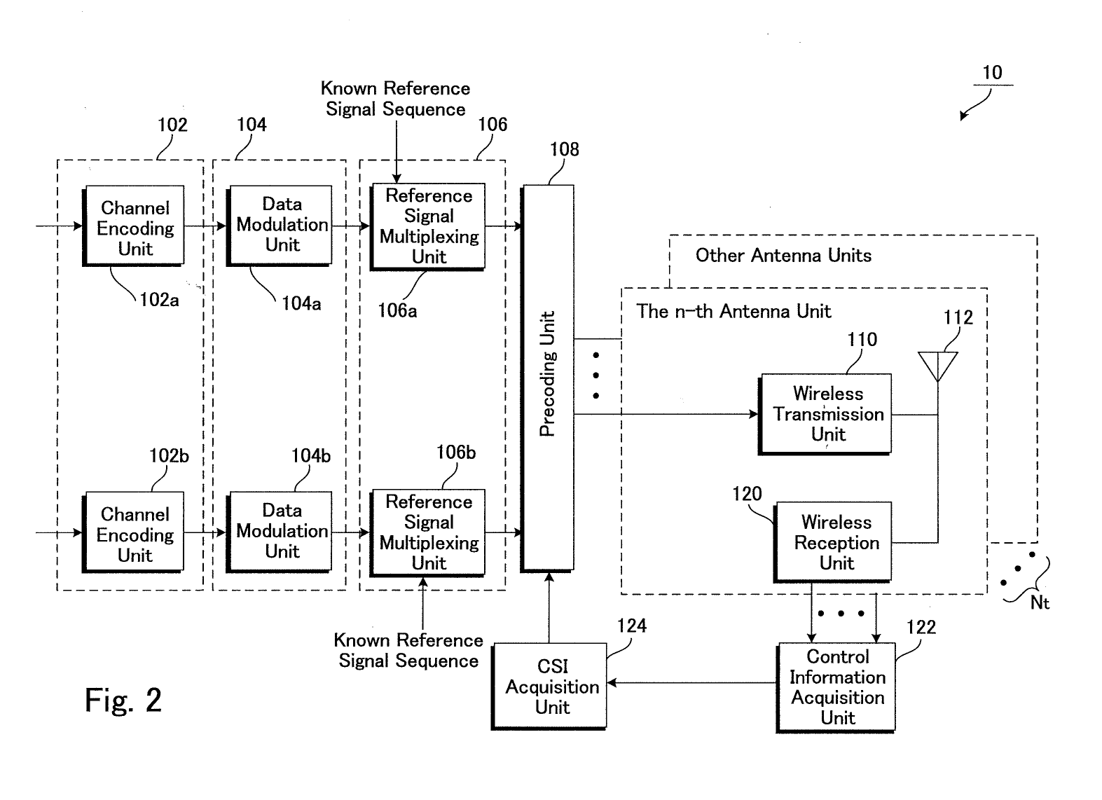

FIG. 2 shows a configuration of base station apparatus 10 according to the present embodiment. It is assumed herein that the mobile station apparatuses to be spatially multiplexed are used by the first user and the second user, and that the first user uses first mobile station apparatus 20 and the second user uses second mobile station apparatus 30. The data sequences from individual mobile station apparatuses are input separately.

Transmit data addressed to each mobile station apparatus is input to a channel encoding unit 102 (102a, 102b) and data modulation unit 104 (104a, 104b) and subjected to channel coding and data modulation. For example, in FIG. 2, the data sequence from first mobile station apparatus 20 is input to channel encoding unit 102a and data modulation unit 104a while the data sequence from second mobile station apparatus 30 is input to channel encoding unit 102b and data modulation unit 104b.

Here, it is assumed that the channel coding rate and data modulation scheme applied to the transmit data addressed to each mobile station apparatus have already been determined based on the control information associated with the receive quality at each mobile station apparatus, notified beforehand from each mobile station apparatus.

The output from data modulation unit 104 is input to reference signal multiplexing unit 106 (106a, 106b) so that a known reference signal sequence for permitting each mobile station apparatus to perform channel estimation is multiplexed in reference signal multiplexing unit 106.

It is assumed that each of the reference signals addressed to individual mobile station apparatuses is multiplexed orthogonally so that the signal can be separated at the mobile station apparatus on the receiving side. In the following description, it is assumed that the reference signal is ideally allocated to arbitrary wireless resource so that the mobile station apparatus can perform ideal channel estimation based on the known reference signal sequence. The output from reference signal multiplexing unit 106 is input to a precoding unit 108.

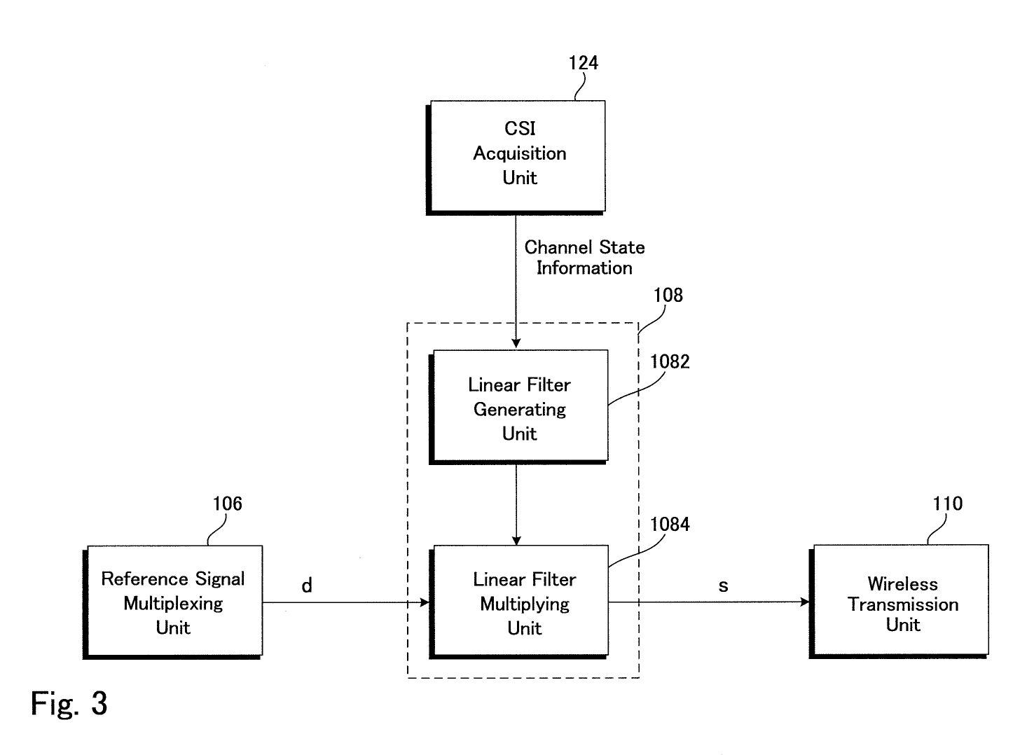

Now, the detailed configuration of precoding unit 108 will be described with reference to FIG. 3. As shown in FIG. 3, precoding unit 108 includes a linear filter generating unit 1082 and a linear filter multiplying unit 1084.

Here, the transmit symbols output from reference signal multiplexing unit 106 to first mobile station apparatus 20 and second mobile station apparatus 30 are named d₁ and d₂, and a transmit symbol vector d is defined as d=[d₁, d₂]^{T}.

In precoding unit 108, first, the CSI (channel state information) on first mobile station apparatus 20 and second mobile station apparatus 30, acquired at a CSI acquisition unit 124 are input to linear filter generating unit 1082, where linear filters are generated.

Next, the CSI input to linear filter generating unit 1082 will be described. The CSI notified by first mobile station apparatus 20 is CSI that is based on the channel state information format called explicit CSI which directly expresses channel state information. The CSI to be notified herein is assumed to be h_{eff,1}=w_{r,1}×H₁, a matrix product of a channel matrix H₁ between base station apparatus 10 and first mobile station apparatus 20, multiplied by a receive filter w_{r,1} that is multiplied on the received signal at first mobile station apparatus 20.

Now, since transmission of rank 1 is performed to first mobile station apparatus 20, receive filter w_{r,1} is given in the form of a (1×Nᵣ) row vector. When transmission with a rank number of R is carried out, receive filter w_{r,1} is given in the form of an (R×Nᵣ) matrix. Since channel matrix H₁ is an (Nᵣ×Nₜ) matrix, the notified information, h_{eff,1} is given in the form of an (R×Nₜ) matrix when transmission with a rank number of R is performed.

On the other hand, the CSI notified from second mobile station apparatus 30 is one that is based on the channel state information format called implicit CSI which indirectly presents channel state information. In the present embodiment, linear transmission filter w_{t,2} requested from base station apparatus 10 by second mobile station apparatus 30 is assumed to be input, similarly to LTE Rel. 8. When transmission of rank 1 is performed like first mobile station apparatus 20, a linear transmission filter w_{t,2} is given in the form of an (Nₜ×1) column vector.

In linear filter generating unit 1082 of base station apparatus 10, it is necessary to generate a desired linear filter by estimating the channel state information between each mobile station apparatus and the base station apparatus, based on the information notified from each mobile station apparatus. The methods disclosed up to the present are limitedly applicable to the cases where the feedback method of channel state information to be notified by each mobile station apparatus is the same with the others. For example, a case in which all the mobile station apparatuses feed back implicit CSI, and the like can be considered.

In the present embodiment, on the assumption that CSI from individual mobile station apparatuses are fed back in different channel state information formats, a channel estimation method and linear filter generating method to be applied to a case where implicit CSI and explicit CSI are fed back in a coexistent status, are newly disclosed.

As for the channel of first mobile station apparatus 20, linear filter generating unit 1082 regards h_{eff,1} given from first mobile station apparatus 20 as it is, as the CSI of the mobile station apparatus 20.

As for second mobile station apparatus 30, w_{t,2}^{H} obtained by Hermitian transposing the notified w_{t,2} is regarded as the channel. Thus, it is possible to define an apparent channel matrix by estimating channel state information as above. When this apparent channel matrix is denoted as H_{eff}, H_{eff} can be expressed in the following Ex. (1).

[Ex. 1]

H_{eff}=(h_{eff,1}/w_{t,2}^{H}) (1)

“H_{eff}” is calculated by combining the channel state information (h_{eff,1} and w_{t,2}^{H}) estimated at base station apparatus 10, in the row direction.

This situation is similar when three or more users make simultaneous access or when transmission of rank 2 or higher is performed to each mobile station apparatus. Further, in the present embodiment, two feedback schemes for implicit CSI and explicit CSI, are targeted, but it is conceivable that there also exists a mobile station apparatus using different feedback scheme from these two feedback schemes.

Also in that case, it is possible to calculate an equivalent channel matrix by properly processing the CSI fed back from the mobile station apparatus and combining the processed CSI with the CSI of the mobile station apparatuses using implicit CSI feedback and Explicit CSI feedback, in the row direction as shown in Ex. (1). From the calculated equivalent channel matrix H_{eff}, a linear filter W_{eff} is calculated as in the following expression (2).

[Ex. 2]

W_{eff}=H_{eff}⁺=H_{eff}^{H}(H_{eff}H_{eff}^{H})⁻¹ (2)

Here, “A⁺” denotes a generalized inverse matrix of a matrix A.

The linear filter given by Ex. (2) is based on a Zero-forcing (ZF) criterion which prevents inter-user interference (IUI) observed at the mobile station apparatus from arising.

Instead of the ZF criterion, a linear filter may be generated based on a minimum mean square error (MMSE) criterion which minimizes the mean square error between the received signal and the transmit signal, a signal-to-leakage power ratio (SLR) criterion which minimizes the influence of the interference power (leakage power) of the transmit signal addressed to a certain mobile station apparatus on other mobile station apparatuses, or a signal-to-leakage plus noise power ratio (SLNR) criterion which maximizes the ratio of the desired signal power to the leakage plus received noise power.

Linear filter W_{eff} generated at linear filter generator 1082 is input to linear filter multiplying unit 1084. In linear filter multiplying unit 1084, transmit symbol vector d input from reference signal multiplexing unit 106 is multiplied by W_{eff} so as to produce a transmit signal vector s=[s₁, . . . , s_{Nt}]^{T}, which is output as a precoding unit output to a wireless transmission unit 110. Here, sₙ represents a transmit signal to be transmitted from the n-th transmit antenna. Given by the following expression is s.

[Ex. 3]

s=W_{eff}d (3)

It should be noted that when the transmit signal vector is generated, power normalization is implemented at the same time so that the transmission power required for transmission of s will not exceed a predetermined level of transmission power.

Returning to FIG. 2, the precoding unit output signal output from precoding unit 108 is input to wireless transmission unit 110 of each transmit antenna. In wireless transmission unit 110, the baseband transmit signal is converted to a transmit signal in the radio frequency (RF) band. The output signal from wireless transmission unit 110 is transmitted from a transmit antenna 112.

Further, CSI acquisition unit 124 acquires channel state information input to linear filter generating unit 1082 of precoding unit 108, from the information notified from each mobile station apparatus. The specific method will be described later.

[Mobile Station Apparatus Configuration]

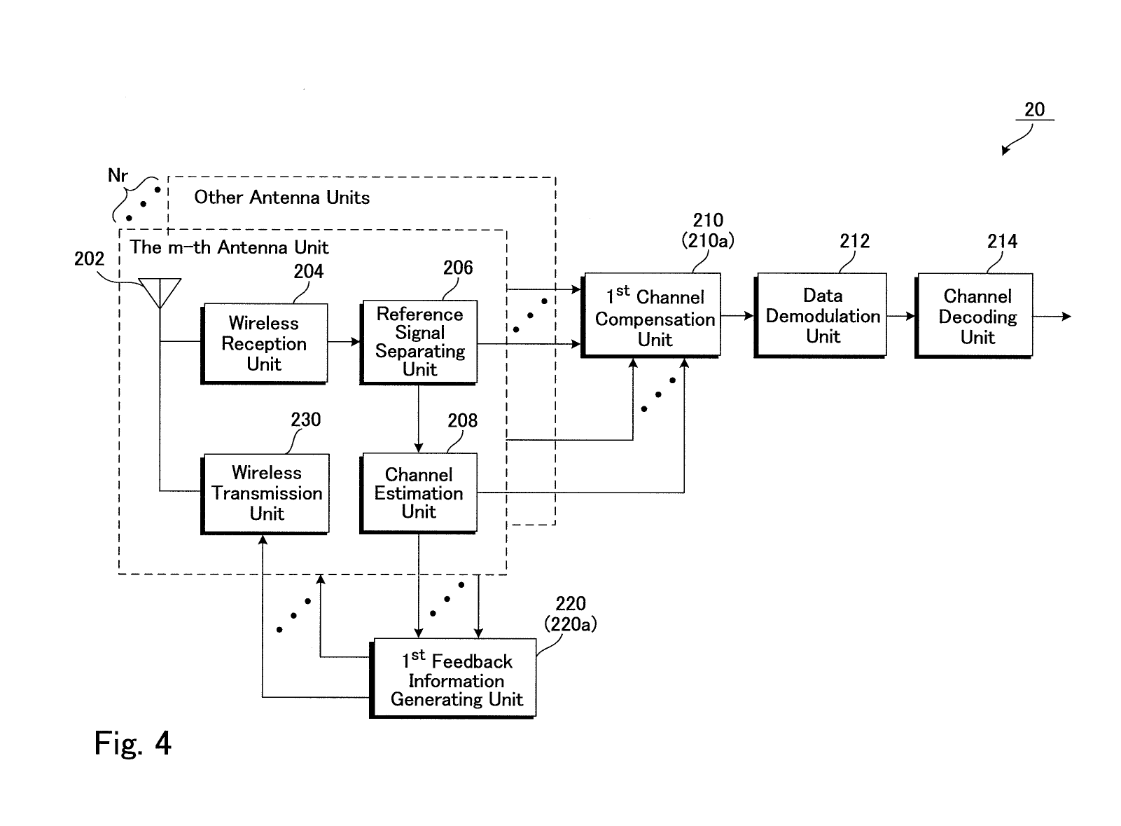

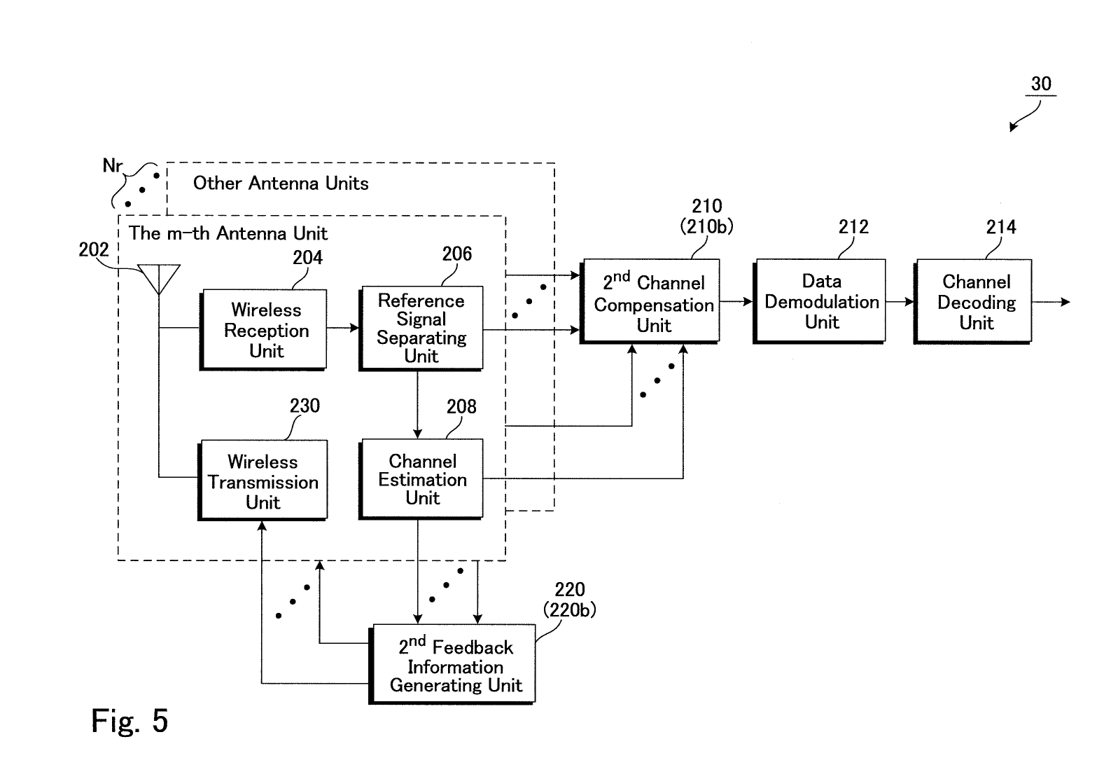

Referring next to the drawings, the configuration of mobile station apparatus will be described. As the mobile station apparatus, FIG. 4 shows first mobile station apparatus 20 and FIG. 5 shows second mobile station apparatus 30.

Herein, the signal processings of the two mobile station apparatuses, i.e., first mobile station apparatus 20 used by the first user and second mobile station apparatus 30 used by the second user, are the same except in the feedback information generating unit and channel compensation unit, so that the components other than the feedback information generating unit and channel compensation unit are allotted with the same reference numerals and their description will be given together.

The mobile station apparatus is comprised of antenna units corresponding to the number of antennas (Nᵣ numbers of antennas), a channel compensation unit 210 (first channel compensation unit 210a in first mobile station apparatus 20 in FIG. 4 or second channel compensation unit 210b in second mobile station apparatus 30 in FIG. 5), a data demodulation unit 212, a channel decoding unit 214 and a feedback information generating unit 220 (first feedback information generating unit 220a in first mobile station apparatus 20 in FIG. 4 or second channel compensation unit 220b in second mobile station apparatus 30 in FIG. 5). The antenna unit is composed of an antenna 202, a wireless reception unit 204, a reference signal separating unit 206, a channel estimation unit 208 and a wireless transmission unit 230.

In the mobile station apparatus, the signal received by each receive antenna 202 is input to corresponding wireless reception unit 204 and converted to a baseband signal. The signal converted in the baseband is input to reference signal separating unit 206. In reference signal separating unit 206, the received signal is separated into a data sequence and a known reference signal sequence. The data sequence is input to channel compensation unit 210 and the known reference signal sequence is input to channel estimation unit 208.

In channel estimation unit 208, channel estimation is implemented using the input known reference signal sequence. Since the known reference signal sequence addressed to each mobile station apparatus is transmitted from base station apparatus 10 so as to be orthogonal to the others, it is possible to estimate channel matrix H₁ in first mobile station apparatus 20 and channel matrix H₂ in second mobile station apparatus 30. The estimated channel matrix is input to channel compensation unit 210 and feedback information generating unit 220.

In feedback information generating unit 220, information to be fed back to base station apparatus 10 is generated in accordance with the channel state information format which each base station apparatus uses for feedback.

First mobile station apparatus 20 used by the first user feeds back channel state information in an information format which explicitly expresses channel state information. First, channel state information H₁ output from channel estimation unit 208 is input to first feedback information generating unit 220a.

In first feedback information generating unit 220a, the input channel matrix H₁ is multiplied by receive filter w_{r,1} to be multiplied at first channel compensation unit 210a so that w_{r,1}×H₁ is output as information to be notified to base station apparatus 10.

The output information is input to wireless transmission unit 230 and will be notified to base station apparatus 10. Here, as to receive filter w_{r,1}, first mobile station apparatus 20 can set up the filter arbitrarily. For example, a linear filter based on an MMSE criterion may be used.

Here, in reality, notification of w_{r,1}×H₁ to base station apparatus 10 may be done by quantizing the information to be notified or w_{r,1}×H₁, into information of a finite bit length and then directly notifying the information, or by having shared a predetermined code book between base station apparatus 10 and first mobile station apparatus 20 and notifying base station apparatus 10 of the number of a code that is closest to the estimated channel state information. Not limited to the above methods, as long as base station 10 can grasp w_{r,1}×H₁, first mobile station apparatus 20 may notify base station apparatus 10 of the channel state information based on the first channel state information format, in any other method.

Since the explicit CSI which first mobile station apparatus 20 notifies is the very channel state information, if all the mobile station apparatuses use the format of first mobile station apparatus 20, base station apparatus 10 can independently determine the precoding method from the information notified. That is, feedback of channel state information in an explicit CSI format can be said to be the action of feeding back information that is good enough for base station apparatus 10 to determine the precoding method by itself, and base station apparatus 10 can actively determine the method of precoding.

On the other hand, second mobile station apparatus 30 used by the second user feeds back channel state information in an information format which implicitly presents channel state information. Similarly to first mobile station apparatus 20, channel state information H₂ output from channel estimation unit 208 is input to second feedback information generating unit 220b.

Second feedback information generating unit 220b, based on the input channel state information H₂, outputs linear transmission filter w_{t,2} that is desirable for its own mobile station as information to be notified to base station apparatus 10. In the first embodiment in which transmission of rank 1 is assumed, the transmission filter w_{t,2} that maximizes ∥H₂×w_{t,2}∥² is notified to base station apparatus 10 (herein, “∥a∥” represents a norm operation of a vector a).

This means that a transmission filter that can maximize the received signal to noise power ratio (SNR) at second mobile station apparatus 30 is notified to base station apparatus 10 when base station apparatus 10 communicates with second mobile station apparatus 30 only.

Here, in reality, notification of the transmission filter to base station apparatus 10 may be done by quantizing the information to be notified or w_{t,2}, into information of a finite bit length and then directly notifying the information, or by having shared a predetermined code book between base station apparatus 10 and second mobile station apparatus 30 beforehand and giving notice of the number of a code that is closest to the required linear filter w_{t,2} to base station apparatus 10.

The method based on a code book may be realized by performing a method of notifying the precoding matrix indicator (PMI) adopted in LTE Rel. 8, for example. Not limited to the above method, as long as base station apparatus 10 can grasp w_{t,2}, second mobile station apparatus 30 may notify base station apparatus 10 of the channel state information based on the second channel state information format, in any other method.

The implicit CSI notified by second mobile station apparatus 30 is not the channel state information itself but information on the method of precoding which the mobile station apparatus wants to base station apparatus 10 to perform (information on a linear filter which base station apparatus 10 is wanted to multiply on the signal to its own mobile station, in the present embodiment).

Accordingly, differing from the case where explicit CSI is fed back, base station apparatus 10 with implicit CSI fed back needs to perform precoding in accordance with the request from the mobile station apparatus. In other words, feedback of channel state information in an implicit CSI format means that the mobile station apparatus actively determines the method of precoding to be done at base station apparatus 10.

Incidentally, it is known that the transmission filter w_{t,2} that maximizes ∥H₂×w_{t,2}∥² under the constraint that transmission power is kept constant becomes the eigenvector corresponding to the largest eigenvalue of a matrix (H₂^{H}H₂).

For description simplicity, the present embodiment has been described on the assumption that base station apparatus 10 can grasp, based on the information notified from second mobile station apparatus 30, that the eigenvector corresponding to the largest eigenvalue of (H₂^{H}H₂) has been notified as transmission filter w_{t,2}.

However, when, for example, transmission filter w_{t,2} is notified to base station apparatus 10 by use of a code book, it is impossible to notice the eigenvector itself because the actual code book is finite in size.

In this case, though it is impossible to completely suppress IUI even using the ZF filter represented by Ex. (2), it is possible to suppress residual IUI by making the code book larger in size or by making each linear filter used by the base station apparatus and receiving station apparatus as the MMSE weight.

Here, when linear filter w_{t,2} is notified to base station apparatus 10, using a predetermined code book, instead of actually determining the eigenvector as mentioned above as for the transmission filter w_{t,2} which maximizes ∥H₂×w_{t,2}∥², it is also possible to extract a linear filter which can maximize ∥H₂×w_{t,2}∥² from the linear filters written on the code book and notify it to the base station apparatus.

There is also a case where explicit CSI and implicit CSI involved in the present embodiment are different in the number of bits required for feedback. That is, already stated, since explicit CSI is the channel state information itself, for example, when the elements of h_{eff,1} are each quantized in some bits to be fed back, bits of the number of transmit antennas Nₜ×the number of bits of each element are needed. On the other hand, when a code number selected from the predetermined code book is notified as the implicit CSI, the number of bits for identifying each code is good enough.

Thus, it could also be said that the two feedback methods in the present embodiment are different in the quantity of feedback (the number of bits).

As described heretofore, feedback information generating unit 220 (first feedback information generating unit 220a or second feedback information generating unit 220b) in each mobile station apparatus generates information to be notified to base station apparatus 10, based on individual different channel state information formats. The generated information is input to wireless transmission unit 230 and notified to base station apparatus 10.

In base station apparatus 10, CSI acquisition unit 124 acquires channel state information (h_{eff,1} or w_{t,2}) from the notified information, based on individual information formats, and the acquired channel state information is input to linear filter generating unit 1082 of precoding unit 108.

On the other hand, the received data sequence is input to first channel compensation unit 210a or second channel compensation unit 210b, where channel compensation is performed by multiplying the data sequence by the receive filter calculated based on channel estimation information input from channel estimation unit 208.

In the case of first mobile station apparatus 20, it is possible in first channel compensation unit 210a to perform channel compensation by directly using the receive filter w_{r,1} that was calculated when channel state information was notified to base station apparatus 10. It is also possible to re-calculate a receive filter by taking residual IUI into account. For example, there is a method using a receive filter based on an MMSE criterion.

In the case of second mobile station apparatus 30, it is possible in second channel compensation unit 210b to maximize reception SNR by using, as a receive filter, w_{r,2}=(H₂×w_{t,2})^{H} based on the linear transmission filter w_{t,2} that was notified to base station apparatus 10 and the already estimated channel state information H₂. Further, it is also possible to separately calculate a receive filter taking residual IUI into account, similarly to first mobile station apparatus 20 and use it.

Here, when each mobile station apparatus re-calculates a receive filter, there occurs a case in which the mobile station apparatus needs to have grasped what linear filter the base station apparatus 10 actually uses. In such a case, base station apparatus 10 may be adapted to transmit a known reference signal sequence different from the known reference signal sequence for allowing each mobile station apparatus to estimate channel state information.

In this case, the separately transmitted known reference signal sequence is multiplied on the linear filter (e.g., the ZF filter given by Ex. (2)) being used for actual data transmission and then transmitted. The mobile station apparatus may re-calculate a reception linear filter based on the known reference signal sequence multiplied by the linear filter.

Each output from first channel compensation unit 210a and second channel compensation unit 210b is input to data demodulation unit 212 and channel decoding unit 214, through which data demodulation and channel decoding are applied, then the transmitted data addressed to each mobile station apparatus is detected.

In the present embodiment, no restriction is imposed on the transmission scheme (or access scheme). For example, the embodiment can be applied to an orthogonal frequency division multiple access (OFDMA) scheme, which is adopted for LTE downlink transmission. In this case, the present embodiment can be applied to every subcarrier, or may be applied to each resource block that is made up of a plurality of subcarriers.

Similarly, the embodiment may also be applied to a single carrier-based access scheme (e.g., single carrier frequency division multiple access (SC-FDMA) scheme, etc.), and may applied every frequency component, or the same precoding may be performed over the whole frequency band in order to avoid emphasis of transmission power.

According to the present embodiment, it is possible to realize downlink MU-MIMO transmission even when mobile station apparatuses which feed back CSI in different information formats coexist. This means that it is possible in the current LTE system to realize downlink MU-MIMO transmission without causing any problem with the existing mobile station apparatus that feeds back implicit CSI even if mobile station apparatus which feeds back explicit CSI coexists in the future, hence it is possible to achieve high frequency efficiency while securing backward compatibility.

### The Second Embodiment

Next, the second embodiment will be described. In the second embodiment herein, the components described in the first embodiment are allotted with the same reference numerals and their detailed description is omitted.

In the first embodiment, base station apparatus 10 performs spatial multiplexing based on the information notified from each mobile station apparatus only when the base station spatially multiplexes the mobile station apparatus which feeds back implicit CSI and the mobile station apparatus which feeds back explicit CSI.

Usually, in downlink MU-MIMO based on linear operation, spatial multiplexing is performed by combining users suited to each other for spatial multiplexing. Specifically, mobile station apparatuses that make the linear filter W_{eff} given by Ex. (2) close to an orthogonal matrix are combined or combination of mobile station apparatuses that suppress the required transmission power is sought for spatial multiplexing.

However, depending on the number of mobile station apparatuses connecting to base station apparatus 10 and/or the positional relationship between mobile station apparatuses, there occurs a condition in which any combination of mobile station apparatus will not make linear filter W_{eff} an orthogonal matrix. The second embodiment presents a method of making linear filter W_{eff} more likely to be close to an orthogonal matrix.

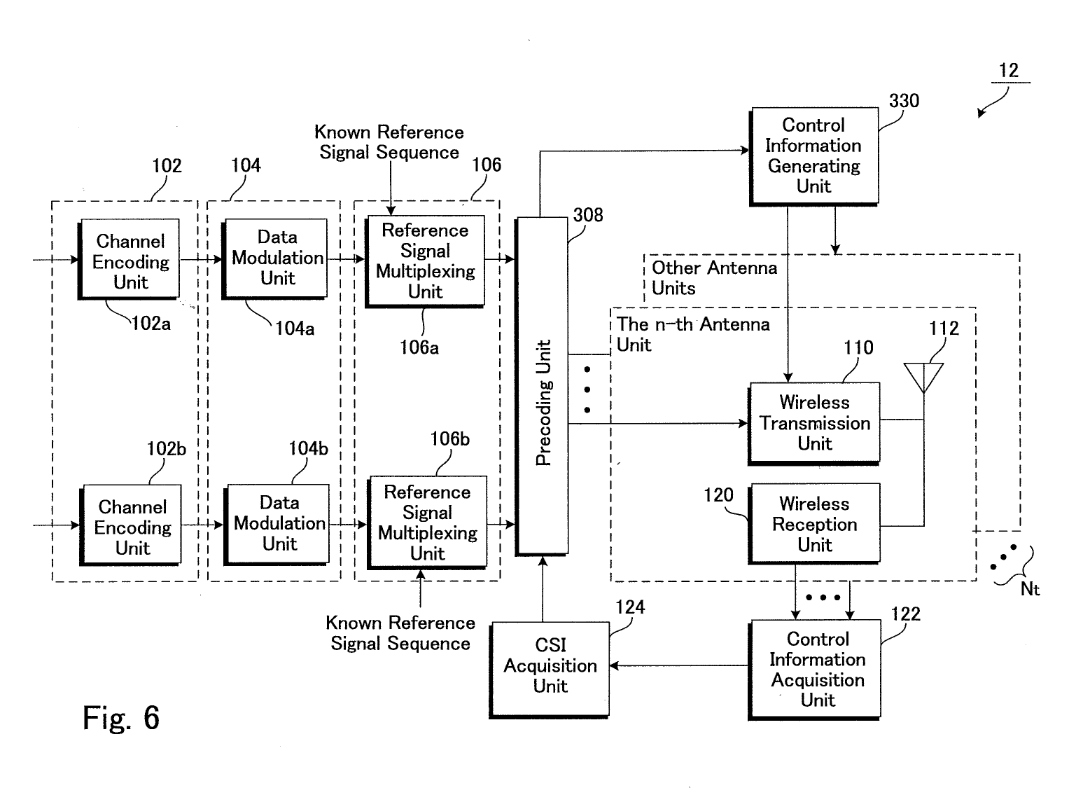

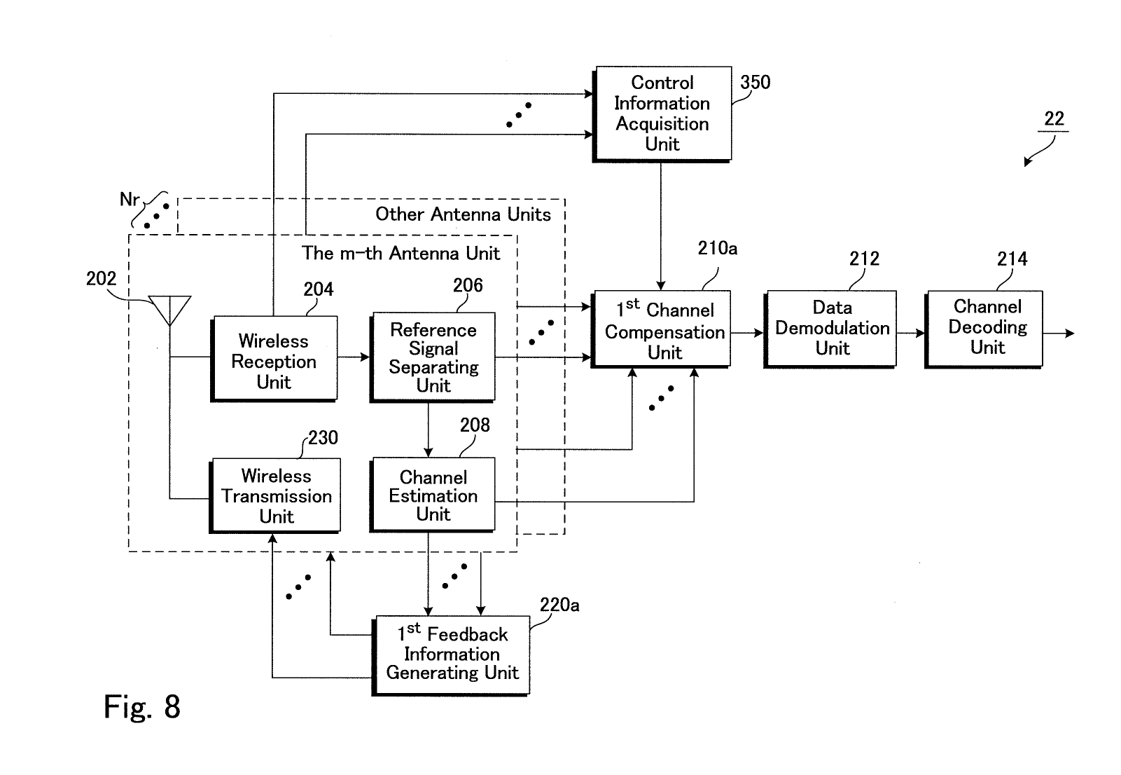

Similarly to the first embodiment, discussion in the second embodiment is made on a case in which two mobile station apparatuses (a first mobile station apparatus 22 (FIG. 8) and a second mobile station apparatus 32) each having Nᵣ numbers of receive antennas are spatially multiplexed on the same wireless resource to a base station apparatus 12 (FIG. 6) having Nₜ numbers of transmit antennas. It is assumed that the first user uses first mobile station apparatus 22 and the second user uses second mobile station apparatus 32.

[Base Station Apparatus Configuration]

FIG. 6 shows base station apparatus 12 according to the second embodiment. Transmit data addressed to each mobile station apparatus is input to channel encoding unit 102 and data modulation unit 104, then multiplexed at reference signal multiplexing unit 106 with a known reference signal sequence for permitting to perform channel estimation at mobile station apparatus.

Herein, the reference signal is multiplexed so as to be separable at mobile station apparatus. In the following description, it is assumed that the reference signal is ideally allocated to arbitrary wireless resource so that the mobile station apparatus can perform ideal channel estimation based on the known reference signal sequence. Further, similarly to the first embodiment, it is also possible to separately transmit a known reference signal sequence multiplied by a linear filter calculated by the aftermentioned method. The output from reference signal multiplexing unit 106 is input to a precoding unit 308.

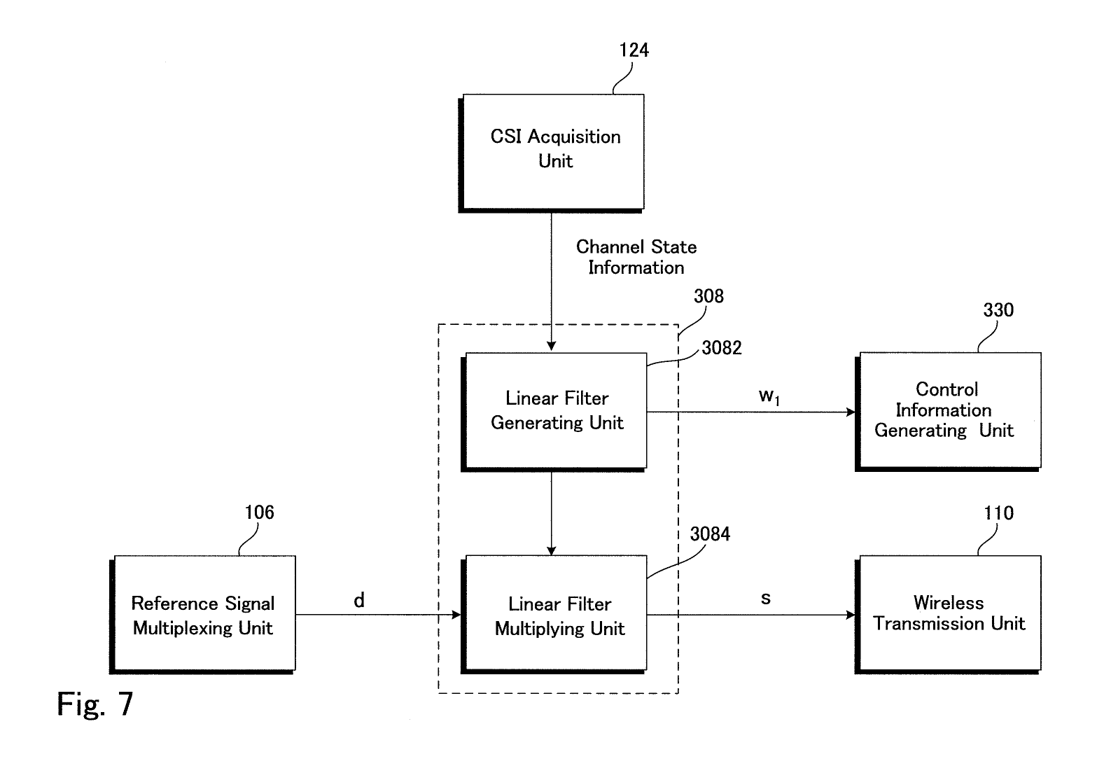

FIG. 7 shows a configuration of precoding unit 308 according to the second embodiment. In precoding unit 308, CSI on first mobile station apparatus 22 and second mobile station apparatus 32, acquired at CSI acquisition unit 124 is input to a linear filter generating unit 3082, where linear filters are generated.

The CSI input to linear filter generating unit 3082 will be described. Although the CSI notified by first mobile station apparatus 22 is one that is based on explicit CSI that directly expresses channel state information, in this embodiment differing from the first embodiment, it is assumed that the channel matrix H₁ between base station apparatus 12 and first mobile station apparatus 22 itself is notified.

On the other hand, it is assumed that a linear transmission filter w_{t,2} requested from base station apparatus 12 by second mobile station apparatus 32 is input as the CSI notified from second mobile station apparatus 32, similarly to second mobile station apparatus 30. As has been stated also in the first embodiment, the following description will be made on the assumption that w_{t,2} is the eigenvector corresponding to the largest eigenvalue of H₂^{H}H₂ or a vector very close to it.

In linear filter generating unit 3082 of base station apparatus 12, channel state information between each mobile station apparatus and base station apparatus 12 is estimated based on the information given from each mobile station apparatus. As for second mobile station apparatus 32, similarly to the first embodiment, w_{t,2}^{H} obtained by Hermitian transposing the notified w_{t,2} is regarded as the channel.

On the other hand, as for the channel of first mobile station apparatus 22, h_{eff, 1}=w₁×H₁ obtained by multiplying H₁ notified from first mobile station apparatus 22 by an arbitrary linear filter w₁ (the first linear filter) is regarded as the channel. By estimating channel state information as above, it is possible to show the apparent channel matrix H_{eff} as the following expression (4).

$$\begin{matrix}[ Ex . 4 ] & \\ {H}_{eff} = ( \begin{matrix}{h}_{eff , 1} \\ {w}_{t , 2}^{H}\end{matrix} ) = ( \begin{matrix}{w}_{1} {H}_{1} \\ {w}_{t , 2}^{H}\end{matrix} ) & ( 4 )\end{matrix}$$

From the calculated equivalent channel matrix H_{eff}, a linear filter W_{eff} is calculated as in the following expression (5).

[Ex. 5]

W_{eff}=H_{eff}⁺=H_{eff}^{H}(H_{eff}H_{eff}^{H})⁻¹ (5)

Ex. (5) is a linear filter based on a ZF criterion used in the first embodiment. Of course, similarly to the first embodiment, a linear filter may also be calculated based on another criterion such as an MMSE criterion.

Now, description will be made on the arbitrary linear filter w₁ that is multiplied when the channel state information of first mobile station apparatus 22 is estimated. In the first embodiment, w₁ is a receive filter that is arbitrarily defined by first mobile station apparatus 22. In the second embodiment, w₁ is determined by base station apparatus 12.

For example, a linear filter which produces a linear filter W_{eff} that can suppress amplification of transmission power is determined as w₁. Since the required transmission power is proportional to the trace (W_{eff}W_{eff}^{H}) (here, “trace (A)” represents the calculation of trace of a matrix A), the linear filter w₁ that can suppress amplification of transmission power can be calculated by solving the minimization problem shown by the following expression (6).

$$\begin{matrix}[ Ex . 6 ] & \\ {w}_{1} = arg {min}_{{w}_{1}} ( trace ( {W}_{eff} {W}_{eff}^{H} ) ) & ( 6 )\end{matrix}$$

Here, “argminₓ(f(x)) is a function of selecting x that minimizes a cost function f(x).

The linear filter may be calculated based on a criterion other than Ex. (6). It is possible to select a w₁ which maximizes channel capacity. Alternatively, a code book in which a plurality of linear filters are written is prepared beforehand, and a linear filter which can minimize the required transmission power, or which can maximize channel capacity, may be selected from the linear filters in the code book to determine linear filter w₁.

The generated linear filter W_{eff} is input from linear filter generating unit 3082 to linear filter multiplying unit 3084. On the other hand, the calculated w₁ is input to a control information generating unit 330, separately from the transmit signal vector which will be generated hereinafter, so that the filter can be notified as receive filter w_{r,1} of first mobile station apparatus 22 to first mobile station apparatus 22.

In linear filter multiplying unit 3084, a transmit symbol vector d is multiplied by the input linear filter W_{eff} so as to generate a transmit signal vector s, which is output from precoding unit 308.

Returning to FIG. 6, the output signal from precoding unit 308 is input to wireless transmission unit 110 corresponding to each antenna 112. In wireless transmission unit 110, the baseband transmit signal is converted to a transmit signal in the radio frequency (RF) band. The output signal from wireless transmission unit 110 is transmitted from each antenna 112. Information on linear filter w₁ output from linear filter generating unit 3082 is also input to wireless transmission unit 110, separately from the transmit signal vector, and notified to first mobile station apparatus 22.

Control information generating unit 330 receives linear filter w₁ and outputs its associated information, which is supplied to wireless transmission unit 110 and then notified to first mobile station apparatus 22. As the information associated with linear filter w₁, linear filter w₁ itself may be notified, or w₁ may be quantized in information of a finite bit length and then the information may be notified. Alternatively, notification may be done by having shared a predetermined code book between base station apparatus 12 and first mobile station apparatus 22 beforehand and giving notice of the number of a code that is closest to the calculated linear filter w₁ to first mobile station apparatus 22.

In the case where a predetermined code book has been shared, a linear filter that is most suited to the calculation criterion (minimum required transmission power criterion or maximum channel capacity criterion) may be selected from the linear filters written on the code book when linear filter w₁ is calculated at precoding unit 308, so that precoding is performed using the selected filter.

[Mobile Station Apparatus Configuration]

Next, the configuration of mobile station apparatus will be described. FIG. 8 is a block diagram showing the configuration of first mobile station apparatus 22. Herein, second mobile station apparatus 32 has the same configuration as that of FIG. 5 and the actual signal processing is the same, so that description of the signal processing in second mobile station apparatus 32 is omitted. Hereinbelow, description of the signal processing in first mobile station apparatus 22 only will be given.

In first mobile station apparatus 22, the signal received by each antenna 202 is input to corresponding wireless reception unit 204 and converted to a baseband signal. The signal converted in the baseband is input to reference signal separating unit 206. In reference signal separating unit 206, the received signal is separated into a data sequence and a known reference signal sequence. The data sequence is input to first channel compensation unit 210a and the known reference signal sequence is input to channel estimation unit 208.

In wireless reception unit 204, information associated with linear filter w₁, notified from control information generating unit 330 of base station apparatus 12 is received separately from the data sequence and the known reference signal sequence. This information is input to control information acquisition unit 350.

In control information acquisition unit 350, the linear filter w₁ generated at precoding unit 308 of base station apparatus 12 is estimated based on the input information, and the estimation is output from control information acquisition unit 350 and supplied to first channel compensation unit 210a.

In channel estimation unit 208, channel estimation is implemented using the input known reference signal sequence. In first mobile station apparatus 22, channel matrix H₁ is estimated. The estimated channel matrix is supplied to first channel compensation unit 210a and first feedback information generating unit 220a.

In first feedback information generating unit 220a, differing from the first embodiment, the estimated channel matrix H₁ is output to wireless transmission unit 230 as information to be directly notified to base station apparatus 12. Here, as an actual notifying method, notification may be done by quantizing the information to be notified into information of a finite bit length and then directly notifying the information, or by having shared in advance a predetermined code book between base station apparatus 12 and first mobile station apparatus 22 and giving notice of the number of a code that is closest to the estimated channel state information to base station apparatus 12, in the similar manner as in the first embodiment.

The reception data sequence input to first channel compensation unit 210a can be processed by channel compensation, by regarding the linear filter w₁ input from control information acquisition unit 350 as receive filter w_{r,1} and multiplying the filter on the received signal. Here, similarly to the first embodiment, a reception linear filter may be newly calculated based on the channel state information H₁ estimated at channel estimation unit 208.

The output from first channel compensation unit 210a is input to data demodulation unit 212 and channel decoding unit 214, through which data demodulation and channel decoding are applied, then the transmit data addressed to each mobile station apparatus is detected.

In the present embodiment, since it is possible for base station apparatus 12 to create a matrix of higher orthogonality for the linear filter W_{eff} calculated at precoding unit 308 of base station apparatus 12, by controlling the receive filter of first mobile station apparatus 22, it is possible to increase the number of combination of mobile station apparatus capable of being spatially multiplexed, compared to the first embodiment.

In MU-MIMO, the greater the number of users to be spatially multiplexed at the same time, the more the frequency efficiency can be improved. Accordingly, it is possible to expect remarkable improvement of frequency efficiency, by using the method of the present embodiment.

### The Third Embodiment

Next, the third embodiment will be described. The second embodiment showed a method that enables base station apparatus 12 to control the receive filter of first mobile station apparatus 22 that notifies explicit CSI and thereby increase the opportunity of spatial multiplexing of mobile station apparatus including the user using second mobile station apparatus 32 that notifies implicit CSI.

However, in the second embodiment, the frequency efficiency of the whole system can be improved, whereas there is a possibility of transmission performance of first mobile station apparatus 22 itself being degraded because the receive diversity gain of first mobile station apparatus 22 is not maximized.

The third embodiment discloses a method of spatially multiplexing first mobile station apparatus 22 and second mobile station apparatus 30 at the same time without degrading the transmission performance of first mobile station apparatus 22 itself.

Similarly to the first and second embodiments, discussion in the third embodiment is made on a case in which two mobile station apparatuses (called first mobile station apparatus 22 and a second mobile station apparatus 30) each having a single receive antenna are spatially multiplexed on the same wireless resource to base station apparatus 12 having Nₜ numbers of transmit antennas. It is assumed that the first user uses first mobile station apparatus 22 and the second user uses second mobile station apparatus 30.

[Base Station Apparatus Configuration]

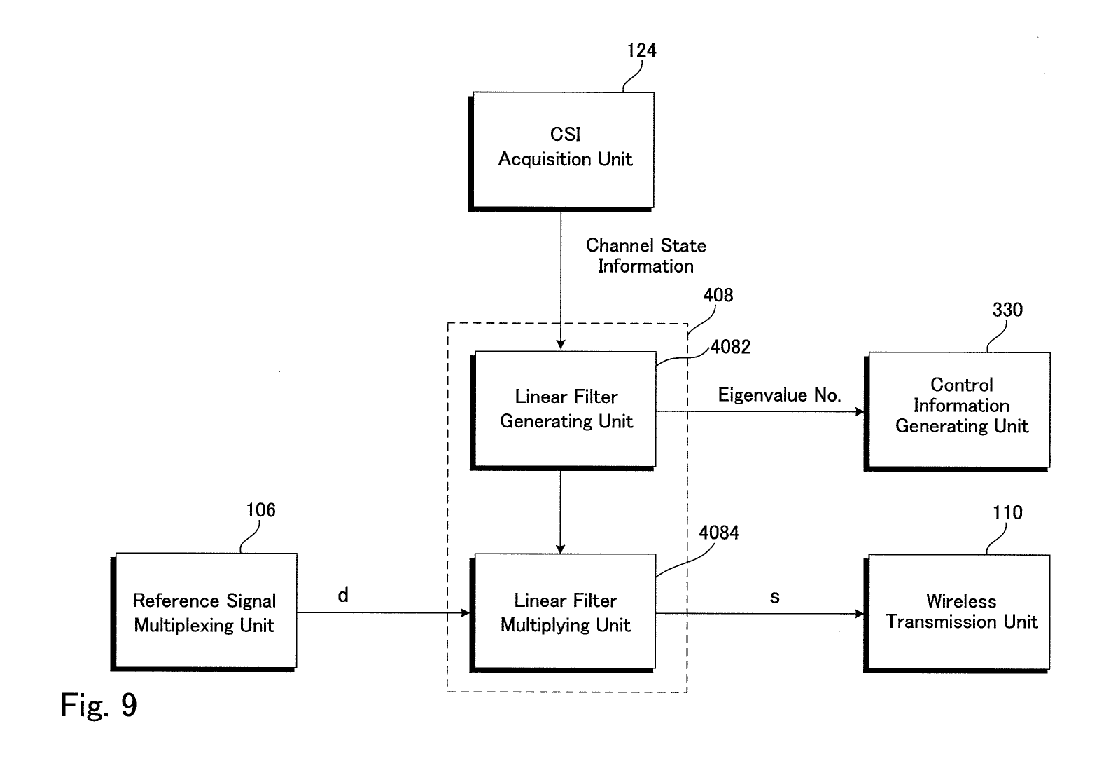

A base station apparatus 14 according to the third embodiment has the configuration shown in FIG. 6 in which precoding unit 308 is replaced by a precoding unit 408 shown in FIG. 9. Difference herein resides in the signal processing in the precoding unit and control information output to control information generating unit 330. The other signal processing is substantially the same as that of base station apparatus 12 in the second embodiment. In the following description, only the processing in precoding unit 408 and control information generating unit 330 will be described.

FIG. 9 shows the configuration of precoding unit 408 according to the third embodiment of the present invention. In precoding unit 408, first, CSI on first mobile station apparatus 22 and second mobile station apparatus 30, acquired at CSI acquisition unit 124 is input to a linear filter generating unit 4082, where linear filters are generated.

The CSI input to linear filter generating unit 4082 will be described. The CSI notified from first mobile station apparatus 22 is explicit CSI that directly expresses channel state information. It is assumed herein that the channel matrix H₁ between base station apparatus 14 and mobile station apparatus 22 is directly notified similarly to the second embodiment. On the other hand, similarly to the first embodiment, it is assumed that linear transmission filter w_{t,2} requested from base station apparatus 12 by second mobile station apparatus 30 is input as the CSI notified from second mobile station apparatus 30.

In linear filter generating unit 4082 of base station apparatus 14, channel state information between each mobile station apparatus and the base station apparatus is estimated based on the information given from each mobile station apparatus. As for second mobile station apparatus 30, similarly to the first embodiment, w_{t,2}^{H} obtained by Hermitian transposing the notified w_{t,2} is regarded as the channel. On the other hand, as for the channel of first mobile station apparatus 22, in linear filter generating unit 4082 the channel state information H₁ acquired first is subjected to eigenvalue decomposition shown by the following expression (7).

[Ex. 7]

H₁^{H}H₁=U₁Λ₁U₁^{H} (7)

Here, “Λ₁” is an (Nₜ×Nₜ) diagonal matrix having the eigenvalues of H₁^{H}H₁ as its diagonal elements and represented as Λ₁=diag{λ₁, . . . , λ_{Nr}, 0, . . . , 0}.

Here, it is assumed that Nₜ≧Nᵣ. On the other hand, “U₁” is an Nₜ×Nₜ unitary matrix represented as U₁=[u_{1,1}, . . . , u_{1,r}, . . . , u_{1,Nt}]. Of the Nₜ column vectors forming U₁, the r-th column vector u_{1,r} is an eigenvector (second linear filter) corresponding to the r-th eigenvalue (i.e., λᵣ).

Linear filter W_{eff} in the third embodiment is implemented mainly based on Λ₁ and U₁. In the following description, it is assumed that diagonal elements of Λ₁ are arranged in the order from the greatest eigenvalue. That is, it is assumed that λ₁>λ₂ . . . >λ_{Nr}>0.

Here, if, instead of channel state information H₁, a covariance matrix Rₜ of H₁ or control information associated with the covariant matrix is notified from first mobile station apparatus 22, the same signal processing may be performed by regarding Rₜ≈H₁^{H}H₁.

In the present embodiment in which transmission of rank 1 to each mobile station apparatus is assumed, linear filter W_{eff} to be calculated is an (Nₜ×2) matrix, where the first column vector represents the linear filter to be multiplied on the transmission data addressed to first mobile station apparatus 22 and the second column vector represents the linear filter to be multiplied on the transmission data addressed to second mobile station apparatus 30.

In the present embodiment, the linear filter to be multiplexed on the transmission data addressed to first mobile station apparatus 22 is adapted to use the eigenvector u_{1,1} corresponding to the largest eigenvalue, among the calculated eigenvectors as above.

Subsequently, as for the linear filter to be multiplexed on the transmit data addressed to second mobile station apparatus 30, among the eigenvectors calculated in association with the channel state information of first mobile station apparatus 22 based on Ex. (7), from the eigenvectors other than the eigenvector corresponding to the largest eigenvalue an eigenvector closest to the desired transmission linear filter w_{t,2} that was notified from second mobile station apparatus 30 is selected and multiplied on the transmit data addressed to second mobile station apparatus 30. To be simple, it is assumed herein that w_{t,2} coincides with u_{1,2}. In this condition, the linear filter to be calculated is given as follows.

[Ex. 8]

W_{eff}=(u_{1,1}u_{1,2}) (8-1)

However, usually there never occurs that the notified transmission linear filter w_{t,2} completely coincides with u_{1,2} Further, since the code book shared between base station apparatus 14 and second mobile station apparatus 30 is finite in size, w_{t,2} acquired by base station apparatus 14 is not always the linear filter the second mobile station apparatus 30 truly desires.

By the way, though omitted for simplicity in the description of the embodiments inclusive of first and second embodiments, usually in addition to the information associated with CSI, information associated with receive quality (e.g., control information called Channel quality indicator (CQI) indicating receive quality and/or Rank Indicator (RI) indicating the desired number of data streams in LTE Rel. 8) is notified from each mobile station apparatus to the base station apparatus. The base station apparatus, based on the information associated with receive quality, determines the modulation scheme, channel coding rate, the rank number, user scheduling and the like.

At this time, the information associated with receive quality is also based on the information associated with CSI being notified to the base station apparatus.

For example, in the case of second mobile station apparatus 30, CQI and the like are calculated on the assumption that the desired transmission linear filter w_{t,2} notified to base station apparatus 14 is used. Accordingly, if a linear filter that is not based on w_{t,2} as in Ex. (8-1) is used, the difference between the receive quality being notified to base station apparatus 14 and the actual receive quality would be increased.

To deal with, if the notified transmission linear filter w_{t,2} does not completely coincide with u_{1,2}, w_{t,2} may be used instead of u_{1,2} for the linear filter, as shown in the following expression.

[Ex. 9]

W_{eff}=(u_{1,1}w_{t,2}) (8-2)

Further, similarly to the first and second embodiments, an apparent channel matrix H_{eff} may be defined also in the third embodiment. In this case, H_{eff} is defined as the following expression.

$$\begin{matrix}[ Ex . 10 ] & \\ {H}_{eff} = ( \begin{matrix}{u}_{1 , 1}^{H} \\ {w}_{t , 2}^{H}\end{matrix} ) & ( 9 )\end{matrix}$$

From the calculated equivalent channel matrix H_{eff}, linear filter W_{eff} is calculated as the following equation.

[Ex. 11]

W_{eff}=H_{eff}⁺=H_{eff}^{H}(H_{eff}H_{eff}^{H}) (10)

Ex. (10) is a linear filter based on a ZF criterion. It is of course possible to calculate a linear filter based on another criterion such as an MMSE criterion, similarly to the first embodiment. Here, when w_{t,2} completely coincides with u_{1,2}, Ex. (10) will coincide with Ex. (8-1).

The above is the method of generating linear filter W_{eff} in the third embodiment. The present embodiment has been described by assuming that the mobile station apparatus to be spatially multiplexed are first mobile station apparatus 22 and second mobile station apparatus 30. However, when a desired linear filter notified by another mobile station apparatus of the same type as second mobile station apparatus 30 coincides with, or is very similar to, any of the eigenvectors other the eigenvector corresponding to the largest eigenvalue of first mobile station apparatus 22, that mobile station apparatus may be multiplexed instead of second mobile station apparatus 30.

Conversely, when the mobile station apparatus which is the same type as first mobile station apparatus 22 and has notified channel state information that can produce an eigenvector coinciding with, or close to, the linear filter notified by second mobile station apparatus 30, exists other than first mobile station apparatus 22, instead of first mobile station apparatus 22 the mobile station apparatus in question may be multiplexed with second mobile station apparatus 30.

Usually, in order to maximize the receive quality of first mobile station apparatus 22, it is necessary to use eigenvector u_{1,1} corresponding to the largest eigenvalue as the linear filter to be multiplied on the transmission data addressed to first mobile station apparatus 22. This is because the receive quality of first mobile station apparatus 22 is proportional to the magnitude of the eigenvalue corresponding to the eigenvector used as the linear filter.

However, in a case where first mobile station apparatus 22 can achieve the desired transmission quality by use of transmission based on the second largest eigenvalue, it is possible to perform spatial multiplexing even when the transmission linear filter notified by second mobile station apparatus 30 coincides with u_{1,1}, by using eigenvector u_{1,2} corresponding to the second largest eigenvalue, as the linear filter to be multiplied on the transmit data addressed to first mobile station apparatus 22.

The same thing holds when transmission of rank 2 or greater is done to each mobile station apparatus. For example, when transmission of rank 2 is done to first mobile station apparatus 22, usually, eigenvectors u_{1,1} and u_{1,2} corresponding to the largest and the second largest eigenvalues are used as the linear filters for first mobile station apparatus 22.

In this case, if the linear filters notified by second mobile station apparatus 30 that also performs transmission of rank 2 coincide with eigenvectors u_{1,1} and u_{1,2}, it is impossible in the method of the present embodiment to spatially multiplex the second mobile station apparatus 30 and the first mobile station apparatus 22.

However, if first mobile station apparatus 22 can achieve the desired transmission quality with the third and the fourth largest eigenvalues, it is possible to use eigenvectors u_{1,3} and u_{1,4} corresponding to the third and the fourth largest eigenvalues as the linear filters for first mobile station apparatus 22. In this case, it is possible to spatially multiplex first mobile station apparatus 22 and second mobile station apparatus 30.

In one word, in the present embodiment it is possible to increase the number of choices of mobile station apparatuses that can be spatially multiplexed, by manipulating choice of eigenvectors which first mobile station apparatus 22 uses for actual transmission.

As has been described heretofore, in the present embodiment the eigenvector producing the largest eigenvalue is not always used as the linear filter for first mobile station apparatus 22.

However, it is impossible for first mobile station apparatus 22 to implement correct signal demodulation if the mobile station apparatus has not grasped which eigenvector is used as the linear filter.

Therefore, since it is necessary in the present embodiment to notify first mobile station apparatus 22 of which eigenvector is actually used as the linear filter, the generated linear filter is input from linear filter generating unit 4082 to linear filter multiplying unit 4084 while control information (the eigenvalue number in this case) associated with the eigenvector being used is output to control information generating unit 330 in FIG. 6.

Thereafter, in linear filter multiplying unit 4084 of precoding unit 408, a transmit symbol vector d is multiplied by the input linear filter W_{eff} so as to generate a transmit signal vector s, which is output as an output signal from precoding unit 408.

The output signal output from precoding unit 408 is input to wireless transmission unit 110 corresponding to each antenna. In wireless transmission unit 110, the baseband transmit signal is converted to a transmitted signal in the radio frequency (RF) band. The output signal from wireless transmission unit 110 is transmitted from each transmit antenna 112.

Further, separately from the transmit signal vector, control information associated with the eigenvector being actually used is input from control information generating unit 330 to wireless transmission unit 110, and notified to first mobile station apparatus 22.

As the notified control information, the eigenvector number (information on the ordinal number of the eigenvalue corresponding to the eigenvector being used, from the largest, information that indicates that the ordinal number of calculation of the eigenvector being used when the algorithm for calculating eigenvectors are shared by the base station apparatus and mobile station apparatus, and others) may be notified. Alternatively, the eigenvector being actually used may be quantized into information of a finite bit length so that the information is directly notified. Further, a predetermined code book has been shared in advance between base station apparatus 14 and first mobile station apparatus 22, and the number of a code closest to the calculated linear filter w₁ may be notified to first mobile station apparatus 22.

When first mobile station apparatus 22 has determined beforehand the method of selecting an eigenvector to be used for its linear filter, with base station apparatus 14 (for example, use of the eigenvector corresponding to the largest eigenvalue at any case, and so on), the control information generated at control information generating unit 330 does not need to be notified to first mobile station apparatus 22.

Further, as for the known reference signal sequence to be transmitted to the mobile station apparatus, when the known reference signal sequence multiplied by the linear filter calculated at precoding unit 408 is transmitted separately, first mobile station apparatus 22 may estimate the number of eigenvalue being actually used based on that information.

When transmission of a plurality of ranks is performed, there is a case where the antenna port number being actually used for transmission in base station apparatus 14 is related to the transmit stream's number. In this case, since the number of the eigenvector and the transmit stream are related, determination of an eigenvector depending on the receive quality etc., means that the antenna port to be used is determined in accordance with the receive quality. Accordingly, when base station apparatus 14 notifies the antenna port number to be used for data transmission to each mobile station apparatus, it is possible to perform such control that the number of the eigenvector being used is notified to first mobile station apparatus 22, thus making it possible to realize the present invention.

[Mobile Station Apparatus Configuration]

Next, the mobile station apparatuses will be described. As to mobile station apparatus, second mobile station apparatus 30 is the same as that shown in FIG. 5, and the signal processing to be implemented is also the same as that described in the first embodiment (second embodiment), so that description is omitted.

On the other hand, first mobile station apparatus 22 has the same configuration as that shown in the second embodiment in FIG. 8, but the signal processing in control information acquisition unit 350 and first channel compensation unit 210a is different, so that only the signal processing in the above two components will be described and description of the other components is omitted.

First, control information acquisition unit 350 will be described. Differing from the second embodiment, information input to control information acquisition unit 350 is only the information associated with the eigenvector that is being used in precoding unit 408 of base station apparatus 12.

Based on the input information, control information acquisition unit 350 inputs the number of the eigenvalue vector used by base station apparatus 12 to first channel compensation unit 210a. Here, when first mobile station apparatus 22 has determined beforehand the method of selecting an eigenvector to be used for its linear filter with base station apparatus 14, no particular control information is input from control information acquisition unit 350 to first channel compensation unit 210a.

Next, the signal processing in first channel compensation unit 210a will be described. The received data sequence input to first channel compensation unit 210a is subjected to channel compensation by multiplying the sequence by a receive filter calculated based on channel state information H₁ input from channel estimation unit 208 and the control information notified from control information acquisition unit 350.

In first channel compensation unit 210a, first, eigenvalue decomposition is performed on the input channel state information H₁ as shown in Ex. (7) so as to calculate eigenvectors. Then, a receive filter is calculated based on the rank number of current transmission and information notified by control information acquisition unit 350. Now, when transmission of rank 1 is performed and control information that shows that the eigenvector corresponding to the largest eigenvalue was used at precoding unit 408 of base station apparatus 12 is input from control information acquisition unit 350, receive filter w_{r,1} is given by the following expression.

[Ex. 12]

w_{r,1}=(H₁u_{1,1})^{H} (11-1)

In the above way, in the third embodiment, the reception filter used by first mobile station apparatus 22 is generated by multiplying channel state information H₁ by the eigenvector which base station apparatus 14 uses in precoding unit 408. For example, suppose that when transmission of rank 2 is being performed, base station apparatus 14 uses eigenvectors u_{1,1} and u_{1,3} corresponding to the largest eigenvalue and the third largest eigenvalue as the transmission filters, the receive filter is given as follows.

[Ex. 13]

w_{r,1}=(H₁[u_{1,1},u_{1,3}])^{H} (11-2)

Instead of newly calculating eigenvectors, it is also possible to directly calculate a receive filter based on a MMSE criterion and use the filter, similarly to the first and second embodiments.

The above is the description of the signal processing in control information acquisition unit 350 and first channel compensation unit 210a. The signal processing in the other components is the same as that in the second embodiment, so that description is omitted.

The third embodiment was discussed on the method of calculating linear filters used at base station apparatus 14 when first mobile station apparatus 22 which feeds back explicit CSI and second mobile station apparatus 30 which feeds back implicit CSI are spatially multiplexed on the same wireless resource, mainly based on the channel state information notified from first mobile station apparatus 22. Differing from the second embodiment, the third embodiment enables first mobile station apparatus 22 and second mobile station apparatus 30 to be spatially multiplexed without degrading receive quality of first mobile station apparatus 22.

### The Fourth Embodiment

In the first to third embodiments, the signal processing performed in the precoding unit of base station apparatus 12 involves linear operations only. This kind of MU-MIMO transmission is called linear MU-MIMO transmission. The MU-MIMO transmission adopted in LTE Rel. 8 is linear MU-MIMO transmission. In the fourth embodiment, non-linear MU-MIMO transmission which involves non-linear signal processing in the precoding unit is taken up for discussion.

Similarly to the first, second and third embodiments, discussion in the fourth embodiment is made on a case in which two mobile station apparatuses (called first mobile station apparatus 20 and second mobile station apparatus 30) each having a single receive antenna are spatially multiplexed on the same wireless resource to a base station apparatus 16 having Nₜ numbers of transmit antennas. It is assumed that the first user uses first mobile station apparatus 20 and the second user uses second mobile station apparatus 30.

[Base Station Apparatus Configuration]

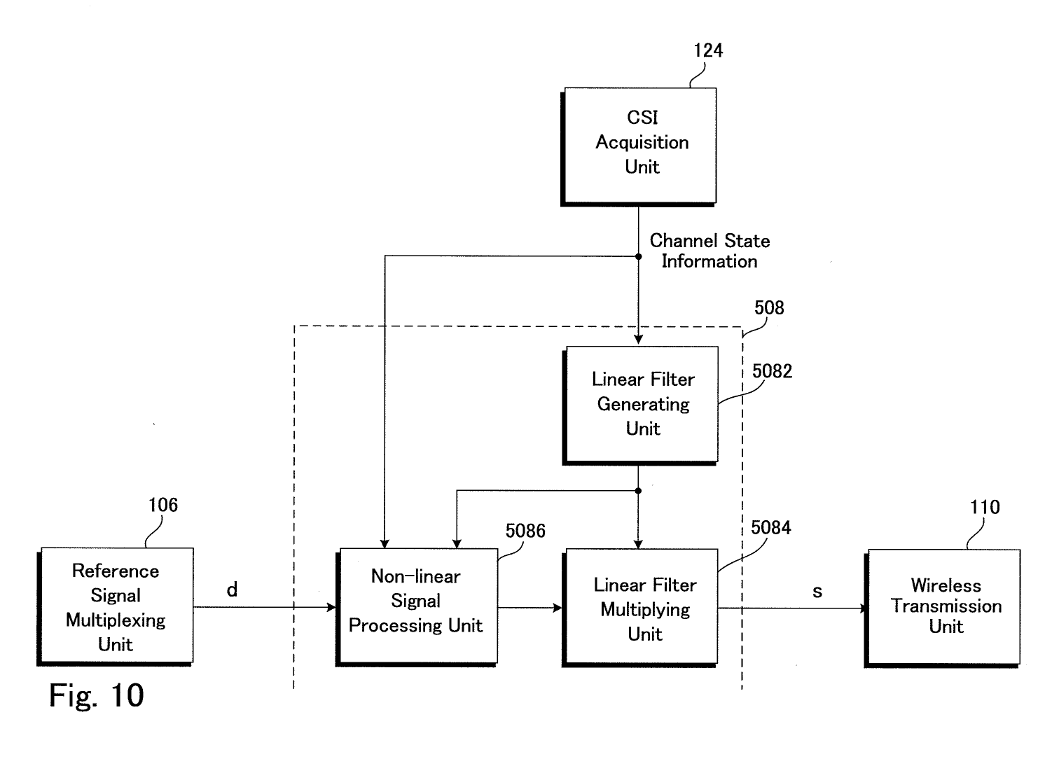

A base station apparatus 16 according to the fourth embodiment has approximately the same configuration as base station apparatus 10 of the first embodiment, in which a precoding unit 508 in FIG. 10 is provided in place of precoding unit 308. Specifically, difference herein resides in the signal processing in precoding unit 508, and the other signal processing is substantially the same as that of the base station apparatus in the first embodiment. In the following description, only the processing in precoding unit 508 will be described.

FIG. 10 shows a configuration of precoding unit 508 in base station apparatus 16 in the fourth embodiment. Precoding unit 508 includes a non-linear signal processing unit 5086, in addition to a linear filter generating unit 5082 and a linear filter multiplying unit 5084.

First, the signal processing in linear filter generating unit 5082 will be described. CSI input to linear filter generating unit 5082 is the same as that of the first embodiment. It is assumed that the information notified from first mobile station apparatus 20 is h_{eff,1}=w_{r,1}×H₁, a matrix product of channel matrix H₁ between base station apparatus 16 and first mobile station apparatus 20 and receive filter w_{r,1} to be multiplied on the received signal at the receiving apparatus of first mobile station apparatus 20 while the CSI notified from second mobile station apparatus 30 is linear transmission filter w_{t,2} which second mobile station apparatus 30 requests from base station apparatus 16.

It is necessary in linear filter generating unit 5082 of base station apparatus 16 to estimate channel state information between each mobile station apparatus and the base station apparatus based on the information notified from each mobile station apparatus. The estimated apparent channel matrix H_{eff} is defined as following expression.

$$\begin{matrix}[ Ex . 14 ] & \\ {H}_{eff} = ( \begin{matrix}{w}_{t , 2}^{H} \\ {h}_{eff , 1}\end{matrix} ) & ( 12 \text{-} 1 )\end{matrix}$$

The above expression is similar to Ex. (1) but the row components are permuted. Specifically, the channel state information of second mobile station apparatus 30 is put in the first row and the channel state information of first mobile station apparatus 20 is put in the second row.

From the estimated channel state information H_{eff}, a linear filter W_{eff} is generated. The linear filters W_{eff} generated in the first, second and third embodiments are essentially a linear filter that performs control such that a transmit signal addressed to a certain mobile station apparatus will no interfere with other mobile station apparatus, and such a linear filter can be determined by performing an inverse-matrix operation on H_{eff}, for example. However, if the inverse matrix of H_{eff} is used as a linear filter, there is a case that an enormous amount of transmission power is needed depending on the form of H_{eff}.

On the other hand, linear filters which are calculated by non-linear operation processing is not limited to the inverse matrix of H_{eff}. Hereinbelow, as an example of non-linear MU-MIMO scheme, a case in which an interference suppression technique called Tomlinson-Harashima Precoding (THP) is used will be described.

In a case of using THP, the generated linear filter W_{eff} is a matrix that converts channel state information H_{eff} into a lower triangular matrix. Such a matrix can be determined by applying QR decomposition to H_{eff}^{H}, the adjoint matrix of H_{eff}. That is, when H_{eff}^{H} is QR-decomposed so that H_{eff}^{H}=QR (Q is a unitary matrix and R is an upper triangular matrix), Q forms linear filter W_{eff}. Here, it is assumed that the following equation holds.

$$\begin{matrix}[ Ex . 15 ] & \\ \begin{matrix}{H}_{eff} {W}_{eff} = {H}_{eff} Q \\ = {R}^{H} \\ = ( \begin{matrix}{r}_{1 , 1} & 0 \\ {r}_{2 , 1} & {r}_{2 , 2}\end{matrix} )\end{matrix} & ( 13 \text{-} 1 )\end{matrix}$$

When the thus generated linear filter W_{eff} is used, H_{eff}W_{eff} will not yield a diagonal matrix, so that the transmit signal addressed to second mobile station apparatus 30 is received by first mobile station apparatus 20 as an interference signal. To deal with this, in precoding unit 508 of the fourth embodiment, this interference signal observed by first mobile station apparatus 20 is subtracted in advance at non-linear signal processing unit 5086.

The signal processing at non-linear signal processing unit 5086 will be described. Input to non-linear signal processing unit 5086 are a modulation symbol d input to precoding unit 508 and H_{eff} and W_{eff} output from linear filter generating unit 5082. In non-linear signal processing unit 5086, the signal processing of subtracting beforehand the aforementioned interference signal observed at first mobile station apparatus 20 is performed. Specifically, the signal processing as shown by the following expression is performed on transmit signal d₁ addressed to first mobile station apparatus 20.

$$\begin{matrix}[ Ex . 16 ] & \\ \begin{matrix}{d}_{1} - {[ {( DIAG ( {H}_{eff} {W}_{eff} ) )}^{- 1} {H}_{eff} {W}_{eff} - I ]}_{2 , 1} = {d}_{1} - \frac{{r}_{2 , 1}}{{r}_{2 , 2}} {d}_{2} \\ = {x}_{1}\end{matrix} & ( 14 \text{-} 1 )\end{matrix}$$

Herein, “DIAG(A)” is a diagonal matrix, and its diagonal elements are assumed to be the diagonal elements of matrix A. “[A]_{i,j}” denotes i-row j-column element of matrix A. “I” is a unit matrix.

When signal x₁ calculated by Ex. (14-1) is used instead of d₁ as the transmit signal addressed to first mobile station apparatus 20, the transmit signal addressed to second mobile station apparatus 30 will not be received by first mobile station apparatus 20 as an interference signal if W_{eff}=Q is used as the linear filter. However, depending on the condition of channel state information H_{eff}, x₁ is greater in magnitude than d₁, there is a possibility of an enormous transmission power being needed. To deal with this, in THP a non-linear signal processing called modulo operation is performed on x₁.

A modulo operation “Mod_{M}(x)” yields an output greater than ?M and falling equal to or smaller than M for a certain input x. Here, “M” is called Modulo width, which is set up in accordance with the modulation scheme or the like of the input signal.

When, for example, a QPSK modulated signal is input, M is set equal to sqrt (2) (M=sqrt (2)). When a modulo operation is actually implemented on the signal x₁ given by Ex. (14-1), the output is given by the following expression.

$$\begin{matrix}[ Ex . 17 ] & \\ {Mod}_{M} ( {x}_{1} ) = {d}_{1} - \frac{{r}_{2 , 1}}{{r}_{2 , 2}} {d}_{2} + 2 Mz & ( 14 \text{-} 2 )\end{matrix}$$

Herein, “z” is a complex number having integers in its real and imaginary parts, respectively. The real part and imaginary part on the right side of Ex. (14-2) are each selected so as to be greater than −M and falls equal to or smaller than M. Here, 2 Mz may also be called perturbation vector. Ex. (14-2) can also be written in the following expression.

$$\begin{matrix} [ Ex . 18 ] & \\ {Mod}_{M} ( {x}_{1} ) = {x}_{1} - 2 M \cdot floor ( \frac{Re ( {x}_{1} )}{2 M} + \frac{1}{2} ) - j 2 M \cdot floor ( ( \frac{Im ( {x}_{1} )}{2 M} + \frac{1}{2} ) ) & ( 14 \text{-} 3 )\end{matrix}$$

Herein, “floor(x)” is a function of returning the greatest integer not greater than a real number x, and is called floor function. “Re(c)” and “Im(c)” are functions that return the real number and the imaginary number of a complex number c, respectively. Implementation of the modulo operation makes it possible to always keep the magnitude of x₁ constant without depending on the condition of channel state information H_{eff}.

The thus calculated x₁ (including the modulo operation) is output as a transmit symbol addressed to first mobile station apparatus 20 from non-linear signal processing unit 5086. The transmit symbol addressed to second mobile station apparatus 30 is not particularly processed through signal processing.

Then, the output from non-linear signal processing unit 5086 is input to linear filter multiplying unit 5084, and is multiplied by linear filter W_{eff}=Q, input from linear filter generating unit 5082. The resultant is output as an output s from precoding unit 508. The signal processing of base station apparatus 10 other than precoding unit 508 is the same as in the first embodiment so that description is omitted.

Heretofore, the signal processing in precoding unit 508 has been described. In the fourth embodiment, a method using THP MU-MIMO was described. This method holds based on the fact that base station apparatus 10 can estimate the received interference component observed at the mobile station apparatus with high precision as to first mobile station apparatus 20 that notifies explicit CSI.

Therefore, when, for example, two users using first mobile station apparatus 20 (named the first and the third users herein) and two users using second mobile station apparatus 30 (named the second and the fourth users herein), four users in total, try to be multiplexed, it is impossible to calculate the linear filters by just applying QR decomposition shown in Ex. (13-1) only. In this case, an apparent channel matrix H_{eff} as follows is defined in the linear filter generating unit.

$$\begin{matrix}[ Ex . 19 ] & \\ {H}_{eff} = ( \begin{matrix}{w}_{t , 2}^{H} \\ {w}_{t , 4}^{H} \\ {h}_{eff , 1} \\ {h}_{eff , 3}\end{matrix} ) & ( 12 \text{-} 2 )\end{matrix}$$

The linear filter W_{eff} to be generated is a matrix that converts the channel matrix represented by Ex. (12-2) to the matrix as follows.

$$\begin{matrix}[ Ex . 20 ] & \\ {H}_{eff} {W}_{eff} = ( \begin{matrix}{r}_{1 , 1} & 0 & 0 & 0 \\ 0 & {r}_{2 , 2} & 0 & 0 \\ {r}_{3 , 1} & {r}_{3 , 2} & {r}_{3 , 3} & 0 \\ {r}_{4 , 1} & {r}_{4 , 2} & {r}_{4 , 3} & {r}_{4 , 4}\end{matrix} ) & ( 13 \text{-} 2 )\end{matrix}$$

That is, basically, matrix conversion is performed in such a manner that residual interference will not remain in the users having notified implicit CSI while residual interference will be given to the users having notified explicit CSI. Such a linear filter W_{eff} can be determined by QR decomposition on H_{eff}^{H} and an inverse matrix operation on a matrix obtained by removing the channel state information relating to the user using the first mobile station apparatus 20 from H_{eff}, or

$$\begin{matrix}[ Ex . 21 ] & \\ {\overline{H}}_{eff} = ( \begin{matrix}{w}_{t , 2}^{H} \\ {w}_{t , 4}^{H} \\ {0}_{1 \times {N}_{t}} \\ {0}_{1 \times {N}_{t}}\end{matrix} ) & ( 12 \text{-} 3 )\end{matrix}$$

Here, “O_{N×m}” denotes an N row M column zero matrix having all its elements zero.

Of the unitary matrix generated from QR decomposition on H_{eff}^{H}, the third and fourth column vector components, and the first and second column vector components of the generalized inverse matrix of the matrix given by Ex. (12-3) are extracted and combined in the column direction, providing a linear filter W_{eff} to be calculated. It should be noted that the method of generating W_{eff} is not limited to this but can be done in any other way as long as Ex. (13-2) is satisfied.

[Mobile Station Apparatus Configuration]

Next, the mobile station apparatus will be described. The configuration of mobile station apparatus according to the fourth embodiment are the same as those of mobile stations according to the first embodiment (FIGS. 4 and 5). In particular, the signal processing in second mobile station apparatus 30 is the same as that in the first embodiment so that description is omitted. The signal processing in first mobile station apparatus 20 is also substantially the same, but the signal processing in first channel compensation unit 210a is a bit different.

In first channel compensation unit 210a, the same signal processing as in the first embodiment is implemented, but it is necessary to apply the same modulo operation as that applied to non-linear signal processing unit 5086 of base station apparatus 10, to the output from first channel compensation unit 210a. For this reason, it is necessary to share the modulo width required for the modulo operation between the base station apparatus and the mobile station apparatus. The signal processing in the other components except first channel compensation unit 210a is the same as in the first embodiment so that description is omitted.

In the fourth embodiment, differing from the first, second and third embodiments, implementation of non-linear signal processing 5086 is targeted. Non-linear MU-MIMO has been reported to achieve frequency usage efficiency more excellent than linear MU-MIMO. In the present embodiment in which mobile terminals which feed back explicit CSI and mobile terminals which feed back implicit CSI coexist, additional use of non-linear signal processing makes it possible to expect a further improvement of frequency usage efficiency.

### Variational Example

As the embodiments of this invention have been described in detail with reference to the drawings, the specific configuration should not be limited to the embodiments. Designs and others that do not depart from the gist of this invention should also be included in the scope of claims.

The program to be operated in the mobile station apparatus and base station apparatus according to the present invention is a program (program that makes a computer function) for controlling the CPU or the like so as to realize the functions of the above embodiments of the present invention. The information to be handed in these apparatuses is temporarily stored in RAM at the time of processing, then is stored into ROM, HDD or the like and is read out, modified and written in by the CPU, as necessary.

The recording medium for storing the program may be any of semiconductor mediums (e.g., ROM, non-volatile memory card, etc.), optical recording mediums (e.g., DVD, MO, MD, CD, BD and the like), magnetic recording mediums (e.g., magnetic tape, flexible disc, etc.), and the like. Further, the functions of the above-described embodiments are not only realized by executing the loaded program, but the functions of the present invention may also be realized in accordance with the instructions of the program by processing in cooperation with an operating system, another application program or the like.

To put the product on the market, the program may be stored on a removable recording medium, or may be transferred to a server computer connected through a network such as the Internet or the like. In this case, the storage device of the server computer is also included in the present invention.

Further, the whole or part of the mobile station apparatus and base station apparatus in the above-described embodiments may be typically realized by an LSI as an integrated circuit. Each functional block of the mobile station apparatus and the base station apparatus may be given individually in the form of a processing unit, or the whole or part may be integrated into a processing unit. The method of circuit integration may be realized in the form of a dedicated circuit or general purpose processing unit, not limited to LSI. It goes without saying that if a technology of circuit integration replacing LSI technologies appears with the progress of semiconductor technologies, the integrated circuit based on that technology can also be used.

As the embodiments of this invention have been described in detail with reference to the drawings, the specific configuration should not be limited to the embodiments. Designs and others that do not depart from the gist of this invention should also be included in the scope of claims.

### DESCRIPTION OF REFERENCE NUMERALS

10, 12, 14, 16 base station apparatus
102, 102a, 102b channel encoding unit
104, 104a, 104b data modulation unit
106, 106a, 106b reference signal multiplexing unit
108 precoding unit
1082 linear filter generating unit
1084 linear filter multiplying unit
110 wireless transmission unit
112 antenna
120 wireless reception unit
122 control information acquisition unit
124 CSI acquisition unit
20 first mobile station apparatus
202 antenna
204 wireless reception unit
206 reference signal separating unit
208 channel estimation unit
210a first channel compensation unit
212 data demodulation unit
214 channel decoding unit
220a first field-back information generating unit
230 wireless transmission unit
30 second mobile station apparatus
210b second channel compensation unit
220b second field-back information generating unit

1. A wireless communication system comprising:
a base station apparatus having a plurality of antennas and
a plurality of mobile station apparatuses each having, at least, one antenna, wherein
the base station apparatus, acquires channel state information of the plurality of mobile station apparatuses, based on any one of a plurality of different channel state information formats, and,
separately precodes data signals addressed to the plurality of mobile station apparatuses based on the channel state information, and spatially multiplexes and transmits the precoded signals; and
the mobile station apparatus receives the precoded signals and detects a desired data signal from the multiplexed signals addressed to mobile station apparatuses, based on the channel state information.

2. The wireless communication system according to claim 1, wherein the plurality of mobile station apparatuses include a first mobile station apparatus and a second mobile station apparatus,
the first mobile station apparatus notifies channel state information between itself and the base station apparatus to the base station apparatus, based on a first channel state information format, and,
the second mobile station apparatus notifies channel state information between itself and the base station apparatus to the base station apparatus, based on a second channel state information format.

3. The wireless communication system according to claim 2, wherein the first channel state information format is an information format that explicitly indicates the channel state information between the base station apparatus and the mobile station apparatus and is comprised of any one of information, among a complex channel matrix between the base station apparatus and the mobile station apparatus, a covariance matrix of a complex channel matrix between the base station apparatus and the mobile station apparatus, or a complex channel matrix represented by a matrix product of a complex channel matrix between the base station apparatus and the mobile station apparatus and a receive filter matrix that is applied in the mobile station apparatus.

4. The wireless communication system according to claim 2, wherein the second channel state information format is an information format that implicitly indicates the channel state information between the base station apparatus and the mobile station apparatus and is comprised of control information associated with precoding which the mobile station apparatus requests from the base station apparatus.

5. The wireless communication system according to claim 4, wherein the control information associated with the precoding is control information for notifying the base station apparatus of a linear filter which the mobile station apparatus requests, based on a plurality of linear filters included in a known code book between the base station apparatus and the mobile station apparatus.

6. The wireless communication system according to claim 1, wherein the base station apparatus, acquires the channel state information of the plurality of mobile station apparatuses, based on any one of the plurality of different channel state information formats,
generates a first linear filter based on the channel state information,
separately precodes data signals addressed to the plurality of mobile station apparatuses based on the channel state information and the first linear filter, and
spatially multiplexes and transmits the precoded signals so as to give a notice of control information associated with the first linear filter to the mobile station apparatus.

7. The wireless communication system according to claim 6, wherein the first linear filter is determined based on either a criterion for minimizing transmission power required for transmitting the precoded signal or a criterion for maximizing a channel capacity of the wireless communication system.

8. The wireless communication system according to claim 6, wherein the control information is control information for giving notice of the first linear filter from the base station apparatus to the mobile station apparatus, based on a plurality of linear filters included in a known code book between the base station apparatus and the mobile station apparatus.

9. The wireless communication system according to claim 2, wherein the base station apparatus, acquires the channel state information of the plurality of mobile station apparatuses, based on any one of the plurality of different channel state information formats, and,
separately precodes data signals addressed to the plurality of mobile station apparatuses, based on the channel state information and a plurality of second linear filters, respectively associated with a plurality of eigenvalues of a channel matrix calculated from the first channel state information format, spatially multiplexes and transmits the precoded signals, and
the base station apparatus gives notice of control information associated with the second linear filters to the mobile station apparatus.

10. The wireless communication system according to claim 9, wherein the base station apparatus determines a linear filter to be used for the precoding, from the plurality of second linear filters, to thereby determine an antenna port to use.

11. The wireless communication system according to claim 1, wherein the precoding is non-linear signal processing including a modulo operation.

12. A base station apparatus, having a plurality of antennas, and connected to a wireless communication system including a plurality of mobile station apparatuses each having, at least, one antenna, comprising:
a channel state information acquisition unit for acquiring channel state information of the plurality of mobile station apparatuses, based on any one of a plurality of different channel state information formats, and,
a precoding unit for separately precoding data signals addressed to the plurality of mobile station apparatuses, based on the channel state information; and,
a transmitter for spatially multiplexing a precoded signal that enables the mobile station apparatus to detect a desired data signal from the multiplexed signals addressed to mobile station apparatuses, based on the channel state information when the mobile station apparatus receives the precoded signal.

13. A mobile station apparatus connected to a wireless communication system including a base station apparatus having a plurality of antennas and a plurality of mobile station apparatuses each having, at least, one antenna, wherein
a base station apparatus includes: a channel state information acquisition unit for acquiring channel state information of a plurality of mobile station apparatuses, based on any one of a plurality of different channel state information formats; and,
a transmitter for separately precoding data signals addressed to the plurality of mobile station apparatuses, based on the channel state information and spatially multiplexing and transmitting the precoded signals, and,
the mobile station apparatus includes a detector for receiving the precoded signals and detecting a desired data signal from multiplexed signals addressed to mobile station apparatuses, based on the channel state information.

14. (canceled)
